(19) United States
(12) Patent Application Publication
(10) Pub. No.: US 2026/0117536 A1
(43) Pub. Date: Apr. 30, 2026

(54) REBAR-TYING TOOL

(71) Applicant: MAKITA CORPORATION, ANJO-SHI (JP)

(72) Inventors: Kazunori KINOSHITA, Anjo-shi (JP); Yuta ASAKURA, Anjo-shi (JP)

(21) Appl. No.: 19/115,840

(22) PCT Filed: Aug. 10, 2023
(86) PCT No.: PCT/JP2023/029236

§ 371 Date: Mar. 27, 2025

(30) Foreign Application Priority Data
Oct. 12, 2022 (JP) 2022-163791

(51) Int. Cl. E04G 21/12; H02K 7/14; H02K 16/00

(52) U.S. Cl. CPC E04G 21/123; H02K 7/14; H02K 16/00

(57) ABSTRACT

A rebar-tying tool includes: a first brushless motor, which feeds a wire that is wound on a reel; a second brushless motor, which twists the wire; a head part, in which the second brushless motor is disposed; a grip part, which extends downward from the head part; a foot part, which is disposed downward of the grip part and to which a battery is connectable; a coupling part, which is disposed forward of the grip part, couples the head part and the foot part, and in which the reel and the first brushless motor are disposed; and a controller, which controls the first brushless motor and the second brushless motor. The controller is disposed in the grip part.

### CROSS-REFERENCE

This application is the US national stage of International Patent Application No. PCT/JP2023/029236 filed on Aug. 10, 2023, which claims priority to Japanese Patent Application No. 2022-163791 filed on Oct. 12, 2022.

### TECHNICAL FIELD

Techniques disclosed in the present specification relate to a rebar-tying tool.

### BACKGROUND ART

A known rebar-tying tool as disclosed in Japanese Laid-open Patent Publication 2022-011577.

### SUMMARY OF THE INVENTION

In embodiments in which a rebar-tying tool employs brushless motors as motive power supplies, a controller is required for controlling the brushless motors. The controller needs to be disposed at a suitable location to avoid undesired enlargement of the rebar-tying tool.

It is therefore one non-limiting object of the present teachings to disclose techniques for disposing a controller at a suitable location in a rebar-tying tool.

In one non-limiting aspect of the present teachings, a rebar-tying tool may comprise: a first brushless motor, which feeds a wire that is wound on a reel; a second brushless motor, which twists the wire; a head part, in which the second brushless motor is disposed; a grip part, which extends downward from the head part; a foot part, which is disposed downward of the grip part and to which a battery connects; a coupling part, which is disposed forward of the grip part, couples the head part and the foot part, and in which the reel and the first brushless motor are disposed; and a controller, which controls the first brushless motor and the second brushless motor; wherein the controller may be disposed in the grip part.

According to the techniques disclosed in the present specification, a controller can disposed at a suitable location in a rebar-tying tool.

### BRIEF DESCRIPTION OF THE DRAWINGS

FIG. 1 is an oblique view, viewed from the upper left and the front, of a rebar-tying tool according to a first embodiment of the present teachings.

FIG. 2 is an oblique view, viewed from the upper left and the rear, of the rebar-tying tool according to the first embodiment.

FIG. 3 is a diagram, viewed from the left, of the internal structure of the rebar-tying tool according to the first embodiment.

FIG. 4 is an exploded, oblique view, viewed from the rear right and below, of a feed motor according to the first embodiment.

FIG. 5 is an exploded, oblique view, viewed from the front right and below, of the feed motor according to the first embodiment.

FIG. 6 is an exploded, oblique view, viewed from the upper right and the front, of the twisting motor according to the first embodiment.

FIG. 7 is an exploded, oblique view, viewed from the upper right and the rear, of the twisting motor according to the first embodiment.

FIG. 8 is a front view that shows a controller according to the first embodiment.

FIG. 9 is a rear view that shows the controller according to the first embodiment.

FIG. 10 is a diagram schematically showing a layout example of the controller according to the first embodiment.

FIG. 11 is a diagram schematically showing a layout example of the controller according to a second embodiment of the present teachings.

FIG. 12 is a diagram schematically showing a layout example of the controller according to a third embodiment of the present teachings.

FIG. 13 is a diagram schematically showing a layout example of the controller according to a fourth embodiment of the present teachings.

FIG. 14 is a diagram schematically showing a layout example of the controller according to a fifth embodiment of the present teachings.

FIG. 15 is an exploded, oblique view, viewed from the rear right and below, of the feed motor according to the fifth embodiment.

FIG. 16 is an exploded, oblique view, viewed from the front right and below, of the feed motor according to the fifth embodiment.

FIG. 17 is an exploded, oblique view, viewed from the upper right and the front, of the twisting motor according to the fifth embodiment.

FIG. 18 is an exploded, oblique view, viewed from the upper right and the rear, of the twisting motor according to the fifth embodiment.

FIG. 19 is a front view that shows the controller according to the fifth embodiment.

FIG. 20 is a diagram schematically showing a layout example of the controller according to a sixth embodiment of the present teachings.

FIG. 21 is a diagram schematically showing a layout example of the controller according to a seventh embodiment of the present teachings.

FIG. 22 is a diagram schematically showing a layout example of the controller according to an eighth embodiment of the present teachings.

FIG. 23 is a diagram schematically showing a layout example of the controller according to a ninth embodiment of the present teachings.

FIG. 24 is a diagram schematically showing a layout example of the controller according to a tenth embodiment of the present teachings.

FIG. 25 is an oblique, schematic diagram that shows the controller according to the tenth embodiment.

FIG. 26 is an exploded, oblique view, viewed from the rear right and below, of the feed motor according to the tenth embodiment.

FIG. 27 is an exploded, oblique view, viewed from the front right and below, of the feed motor according to the tenth embodiment.

FIG. 28 is an exploded, oblique view, viewed from the rear right and below, of the twisting motor according to the tenth embodiment.

FIG. 29 is an exploded, oblique view, viewed from the front right and below, of the twisting motor according to the tenth embodiment.

FIG. 30 is a diagram schematically showing a layout example of the controller according to an eleventh embodiment of the present teachings.

FIG. 31 is a diagram schematically showing a layout example of the controller according to a twelfth embodiment of the present teachings.

### DETAILED DESCRIPTION OF THE INVENTION

As was mentioned above, a rebar-tying tool may comprise: a first brushless motor, which feeds a wire that is wound on a reel; a second brushless motor, which twists the wire; a head part, in which the second brushless motor is disposed; a grip part, which extends downward from the head part; a foot part, which is disposed downward of the grip part and to which a battery is connectable; a coupling part, which is disposed forward of the grip part, couples the head part and the foot part, and in which the reel and the first brushless motor are disposed; and a controller, which controls the first brushless motor and the second brushless motor; wherein the controller may be disposed in the grip part.

In the above-mentioned configuration, the controller is disposed at a suitable location in the rebar-tying tool.

In one or more embodiments, a first cable, which connects the first brushless motor and the controller, may pass through the head part.

In the above-mentioned configuration, the first brushless motor, the controller, and the first cable are disposed at suitable locations in the rebar-tying tool.

In one or more embodiments, the rebar-tying tool may comprise an operation-and-indicator part, which is disposed on the head part. The operation-and-indicator part and the controller may be connected by a second cable.

In the above-mentioned configuration, the operation-and-indicator part, the controller, and the second cable are disposed in a suitable positional relationship in the rebar-tying tool.

In one or more embodiments, the first brushless motor may comprise a first stator and a first rotor, which is disposed in the interior of the first stator. The first brushless motor may be disposed so that the rotational axis of the first rotor extends in a front-rear direction. A first terminal, which (electrically) connects a plurality of (at least two) coils of the first stator, may be disposed at an upper portion of the first stator. A first sensor board, which detects rotation of the first rotor, may be disposed more rearward than the first stator. The first terminal and the controller may be connected by a first power cable. The first sensor board and the controller may be connected by a first signal cable.

In the above-mentioned configuration, the first brushless motor and the controller are disposed in a suitable positional relationship.

In one or more embodiments, the second brushless motor may comprise a second stator and a second rotor, which is disposed in the interior of the second stator. The second brushless motor may be disposed so that the rotational axis of the second rotor extends in a front-rear direction. A second terminal, which (electrically) connects a plurality of (at least two) coils of the second stator, may be disposed at a lower portion of the second stator. A second sensor board, which detects rotation of the second rotor, may be disposed more forward than the second stator. The second terminal and the controller may be connected by a second power cable. The second sensor board and the controller may be connected by a second signal cable.

In the above-mentioned configuration, the second brushless motor and the controller are disposed in a suitable positional relationship.

In one or more embodiments, a rebar-tying tool may comprise: a first brushless motor, which feeds a wire that is wound on a reel; a second brushless motor, which twists the wire; a head part, in which the second brushless motor is disposed; a grip part, which extends downward from the head part; a foot part, which is disposed downward of the grip part and to which a battery is connectable; a coupling part, which is disposed forward of the grip part, couples the head part and the foot part, and in which the reel and the first brushless motor are disposed; and a controller, which controls the first brushless motor and the second brushless motor; wherein the controller may be disposed between the first brushless motor and the second brushless motor in an up-down direction.

In the above-mentioned configuration, the controller is disposed at a suitable location in the rebar-tying tool.

In one or more embodiments, the first brushless motor and the controller may be connected by a first cable. The first cable may be connected to a lower surface of a circuit board of the controller.

In the above-mentioned configuration, the first brushless motor, the controller, and the first cable are disposed with a suitable positional relationship.

In one or more embodiments, the rebar-tying tool may comprise an operation-and-indicator part, which is disposed on the head part. The operation-and-indicator part and the controller may be connected by a second cable. The second cable may be connected to an upper surface of a circuit board of the controller.

In the above-mentioned configuration, the operation-and-indicator part, the controller, and the second cable are disposed at suitable locations in the rebar-tying tool.

In one or more embodiments, the first brushless motor may comprise a first stator and a first rotor, which is disposed in the interior of the first stator. The first brushless motor may be disposed so that the rotational axis of the first rotor extends in a front-rear direction. A first terminal, which (electrically) connects a plurality of (at least two) coils of the first stator, may be disposed at an upper portion of the first stator. A first sensor board, which detects rotation of the first rotor, may be disposed more rearward than the first stator. The first terminal and the controller may be connected by a first power cable. The first sensor board and the controller may be connected by a first signal cable.

In the above-mentioned configuration, the first brushless motor and the controller are disposed with a suitable positional relationship.

In one or more embodiments, the second brushless motor may comprise a second stator and a second rotor, which is disposed in the interior of the second stator. The second brushless motor may be disposed so that the rotational axis of the second rotor extends in a front-rear direction. A second terminal, which (electrically) connects a plurality of (at least two) coils of the second stator, may be disposed at a lower portion of the second stator. A second sensor board, which detects rotation of the second rotor, may be disposed more forward than the second stator. The second terminal and the controller may be connected by a second power cable. The second sensor board and the controller may be connected by a second signal cable.

In the above-mentioned configuration, the second brushless motor and the controller are disposed in a suitable positional relationship.

In one or more embodiments, a rebar-tying tool may comprise: a first brushless motor, which feeds a wire that is wound on a reel; a second brushless motor, which twists the wire; a head part, in which the second brushless motor is disposed; a grip part, which extends downward from the head part; a foot part, which is disposed downward of the grip part and to which a battery is connectable; a coupling part, which is disposed forward of the grip part, couples the head part and the foot part, and in which the reel and the first brushless motor are disposed; and a controller, which controls the first brushless motor and the second brushless motor; wherein a second surface of the circuit board and the first brushless motor may be connected by a cable; and a first surface of the circuit board and the second brushless motor may be connected by a cable.

In the above-mentioned configuration, the controller is disposed at a suitable location in the rebar-tying tool.

In one or more embodiments, the controller may be disposed in the head part.

In the above-mentioned configuration, the controller is disposed at a suitable location in the rebar-tying tool.

In one or more embodiments, the rebar-tying tool may comprise an operation-and-indicator part, which is disposed on the head part. The first surface of the circuit board and the operation-and-indicator part may be connected by a cable.

In the above-mentioned configuration, the operation-and-indicator part, the controller, and the cable are disposed in a suitable positional relationship in the rebar-tying tool.

In one or more embodiments, the first brushless motor may comprise a first stator and a first rotor, which is disposed in the interior of the first stator. The first brushless motor may be disposed so that the rotational axis of the first rotor extends in a front-rear direction. A first terminal, which (electrically) connects a plurality of (at least two) coils of the first stator, may be disposed at an upper portion of the first stator. A first sensor board, which detects rotation of the first rotor, may be disposed more rearward than the first stator. The first terminal and the controller may be connected by a first power cable. The first sensor board and the controller may be connected by a first signal cable.

In the above-mentioned configuration, the first brushless motor and the controller are disposed in a suitable positional relationship.

In one or more embodiments, the second brushless motor may comprise a second stator and a second rotor, which is disposed in the interior of the second stator. The second brushless motor may be disposed so that the rotational axis of the second rotor extends in a front-rear direction. A second terminal, which (electrically) connects a plurality of (at least two) coils of the second stator, may be disposed at a lower portion of the second stator. A second sensor board, which detects rotation of the second rotor, may be disposed more forward than the second stator. The second terminal and the controller may be connected by a second power cable. The second sensor board and the controller may be connected by a second signal cable.

In the above-mentioned configuration, the second brushless motor and the controller are disposed in a suitable positional relationship.

In one or more embodiments, at least one of the first brushless motor and the second brushless motor may have a sensor board, which detects rotation of a rotor. The sensor board may have an inverter circuit for motor driving.

In the above-mentioned configuration, the configuration of the controller is simplified, and the degrees of freedom for the arrangement of the controller increase.

In one or more embodiments, the controller may comprise a circuit board, which comprises: an inverter circuit for motor driving; and a heat sink, which is thermally connected to the inverter circuit.

In the above-mentioned configuration, temperature rises in the controller can be curtailed.

In one or more embodiments, the rebar-tying tool may further comprise a wireless-communication unit, which is provided in the grip part.

In the above-mentioned configuration, the wireless-communication unit and the controller are disposed with a suitable positional relationship.

In one or more embodiments, the rebar-tying tool may comprise a noise-removing member (noise-attenuating member), which removes (attenuates) electromagnetic noise on an electric-power line that electrically connects at least one of the first brushless motor and the second brushless motor with the controller.

In the above-mentioned configuration, in addition to disposing the brushless motors and the controller in a suitable positional relationship, the influence of electromagnetic noise can be curtailed.

In one or more embodiments, a rebar-tying tool may comprise: a first brushless motor, which feeds a wire that is wound on a reel; a second brushless motor, which twists the wire; a head part, in which the second brushless motor is disposed; a grip part, which extends downward from the head part; a foot part, which is disposed downward of the grip part and to which a battery is connectable; a coupling part, which is disposed forward of the grip part, couples the head part and the foot part, and in which the reel and the first brushless motor are disposed; and a controller, which controls the first brushless motor and the second brushless motor; wherein the controller may be disposed in the foot part; and the controller may comprise: a circuit board; a controller case, which houses the circuit board; and a terminal, which connects the battery and the circuit board.

In the above-mentioned configuration, the controller is disposed at a suitable location in the rebar-tying tool.

Embodiments are explained below, with reference to the drawings. In the embodiments, positional relationships among the parts are explained using the terms left, right, front, rear, up, and down. These terms indicate relative position or direction, wherein the center of a rebar-tying tool 2 is the reference.

### First Embodiment

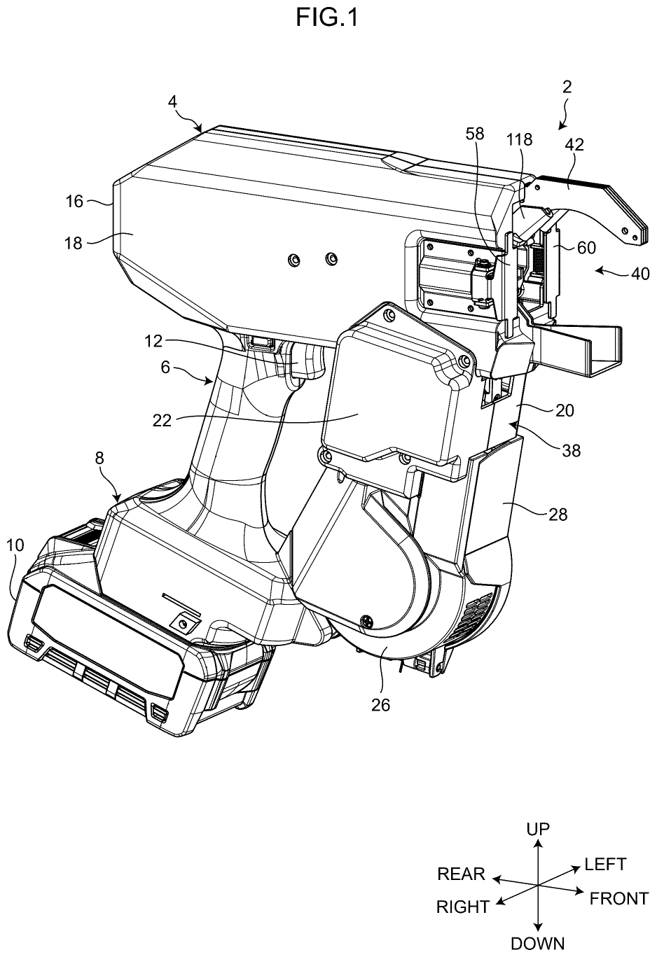

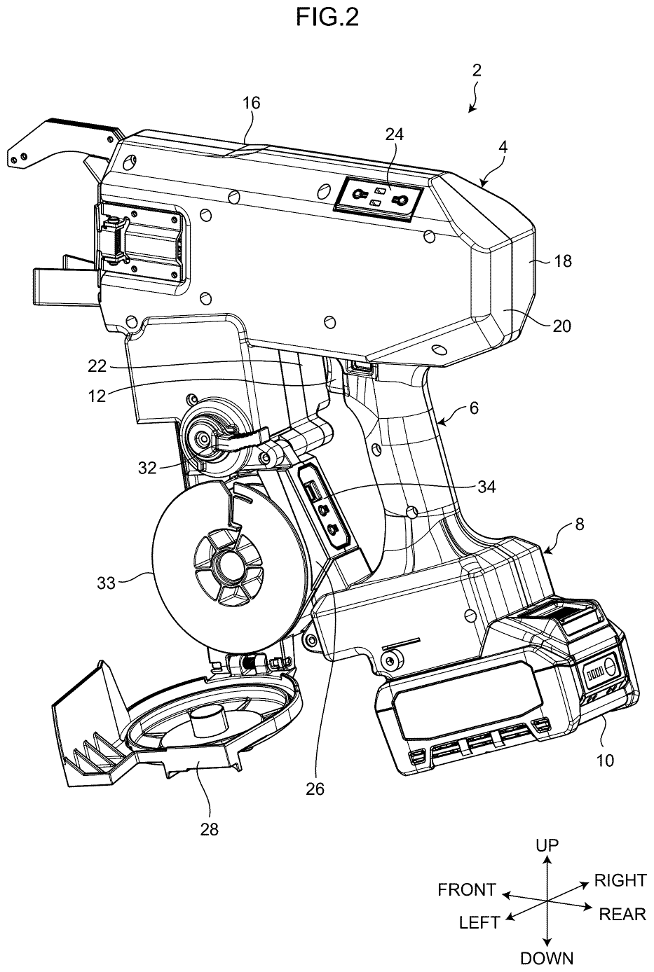

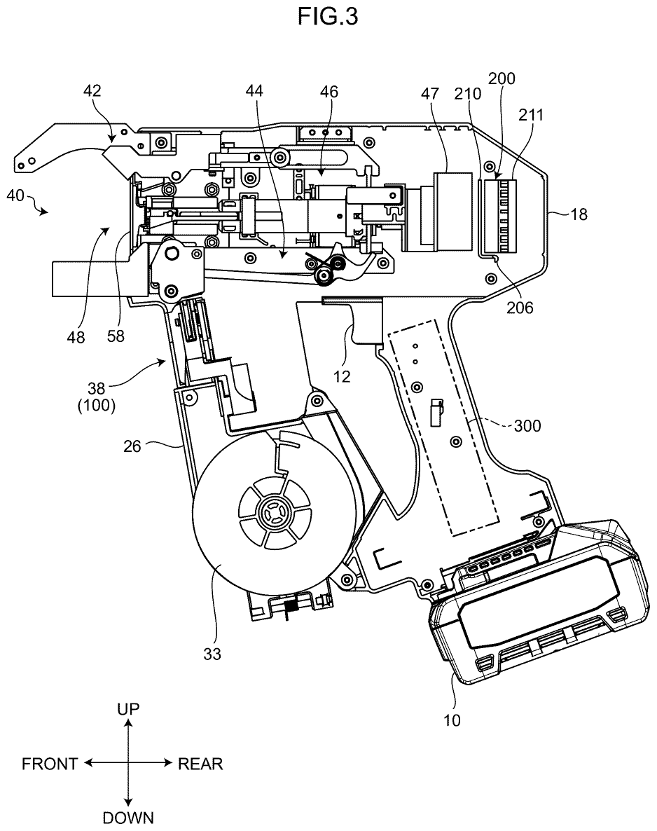

A first embodiment of the present teachings will now be described. FIG. 1 is an oblique view, viewed from the upper left and the front, of the rebar-tying tool 2 according to the present (first) embodiment of the present teachings. FIG. 2 is an oblique view, viewed from the upper left and the rear, of the rebar-tying tool 2 according to the present embodiment. FIG. 3 is a diagram, viewed from the left, of the internal structure of the rebar-tying tool 2 according to the present embodiment. The rebar-tying tool 2 is a power tool for tying a plurality of rebars with a wire.

The rebar-tying tool 2 comprises a feed motor 100, a twisting motor 200, a head part 4, a grip part 6, a foot part 8, a coupling part 26, and a controller 300. The wire is wound on a reel 33. The feed motor 100 feeds the wire that has been wound on the reel 33. The twisting motor 200 twists the wire that is fed from the feed motor 100. The twisting motor 200 is disposed in the head part 4. The grip part 6 extends downward from the head part 4 and is gripped by a user. The foot part 8 is disposed downward of the grip part 6 and is connected to a battery 10. The battery 10 is detachable from a lower portion of the foot part 8. The battery 10 is a slidable-type battery that is detachable by sliding the battery 10 relative to the foot part 8. The battery 10 is a rechargeable lithium-ion battery that can be charged with a charger. When the battery 10 is connected to the foot part 8, electric power is supplied from the battery 10 to the rebar-tying tool 2. Battery terminals, which electrically connect to the battery 10, are provided on a lower surface of the foot part 8. The battery terminals are electrically connected to the controller 300. The coupling part 26 is disposed forward of the grip part 6 and couples the head part 4 and the foot part 8. The reel 33 and the feed motor 100 are disposed on the coupling part 26. The controller 300 controls the feed motor 100 and the twisting motor 200. The controller 300 is disposed in the grip part 6. As used herein, the expression “twists the wire” is intended to mean that two portions of a wire are twisted together to secure or fasten the wire that has been wound (looped) around at least two rebars.

A trigger 12 is mounted on a front-surface upper portion of the grip part 6. The battery 10 is detachable by sliding the battery 10 relative to the foot part 8. The battery 10 comprises a secondary battery such as, for example, a lithium-ion battery.

The rebar-tying tool 2 comprises a housing 16. The housing 16 comprises a right housing 18, a left housing 20, and a motor cover 22. The right housing 18 defines the shape of right-half surfaces of the head part 4, the grip part 6, and the foot part 8. The left housing 20 defines the shape of left-half surfaces of the head part 4, the grip part 6, and the foot part 8. The motor cover 22 is mounted on the outer side of the right housing 18. A first operation-and-indicator part 24 is provided on a rearward upper portion of the left housing 20. The first operation-and-indicator part 24 comprises: a main power switch and a mode-changing switch, which are the manipulable parts; and a main power LED and a mode-indicator LED, which are indicator parts.

The coupling part 26 is coupled to a forward lower portion of the head part 4 and a front portion of the foot part 8. A cover member 28 is mounted on the coupling part 26 to be pivotable about a pivot axis at a lower portion of the coupling part 26. A lock lever 32 is provided at a forward lower portion of the left housing 20 for maintaining (holding) the cover member 28 in a closed state. The reel 33 on which the wire is wound is housed in a housing space in the coupling part 26. The reel 33 is supported in a rotatable manner by the coupling part 26 and the cover member 28.

A second operation-and-indicator part 34 is provided on a rear surface of the coupling part 26. The second operation-and-indicator part 34 comprises: a setting-changing switch, which is a manipulable part; and setting-indicator LEDs, which are the indicator part.

The rebar-tying tool 2 comprises a wire-feeding mechanism 38, a wire-guiding mechanism 40, a rebar-abutting mechanism 42, a wire-cutting mechanism 44, a wire-twisting mechanism 46, a speed-reducing mechanism 47, and a rebar-pressing mechanism 48. The wire-feeding mechanism 38 is housed in the forward lower portion of the head part 4. The wire-guiding mechanism 40 is disposed at a front portion of the head part 4. The rebar-abutting mechanism 42 is disposed at the front portion of the head part 4. The wire-cutting mechanism 44 is housed in a lower portion of the head part 4. The wire-twisting mechanism 46 is housed in the head part 4. The speed-reducing mechanism 47 generates a reduced-speed rotation (as compared to the speed of the rotation of the twisting motor 200) and transmits the reduced-speed rotation to the wire-twisting mechanism 46. The rebar-pressing mechanism 48 is disposed at the front portion of the head part 4. The wire-feeding mechanism 38 comprises the feed motor 100. The rebar-abutting mechanism 42 comprises a contact arm 118. The wire-twisting mechanism 46 comprises the twisting motor 200. The rebar-pressing mechanism 48 comprises a contact plate 58 and a contact plate 60.

When the trigger 12 is manipulated and the feed motor 100 thereby rotates in the forward rotational direction, the wire-feeding mechanism 38 feeds a prescribed length of the wire that is wound around the reel 33. The feed motor 100 stops when the wire is wound (looped) in a circular-ring shape around the rebars and feeding of the wire is complete. After the feeding step is terminated, the wire is cut by the wire-cutting mechanism 44, and the wire is twisted in response to actuation of the twisting motor 200.

### Motor

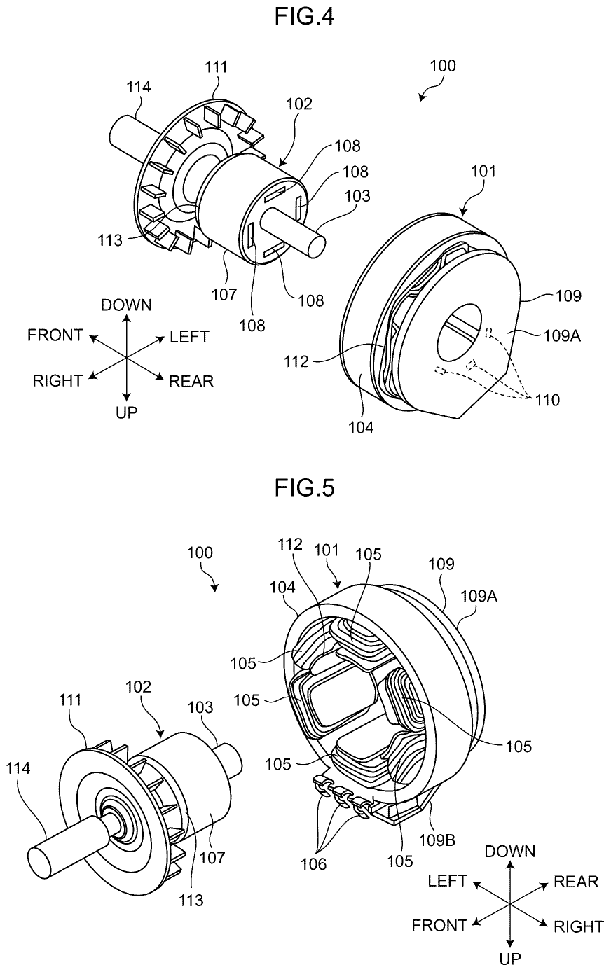

FIG. 4 is an exploded, oblique view, viewed from the rear right and below, of the feed motor 100 according to the present embodiment. FIG. 5 is an exploded, oblique view, viewed from the front right and below, of the feed motor 100 according to the present embodiment. FIG. 7 is an exploded, oblique view, viewed from the front right and above, of the feed motor 100 according to the present embodiment. The feed motor 100 generates a rotational force. The feed motor 100 is an electric motor. The feed motor 100 is preferably an inner-rotor-type brushless motor. The feed motor 100 comprises a stator 101, a rotor 102, and a rotor shaft 103. The stator 101 is disposed around the rotor 102. The rotor 102 is disposed around the rotor shaft 103. The rotor shaft 103 is fixed to the rotor 102. The rotor 102 and the rotor shaft 103 rotate relative to the stator 101. The rotor 102 and the rotor shaft 103 rotate about a rotational axis that extends in the front-rear direction.

The stator 101 comprises a stator core 104, an insulator 112, and coils 105. The stator core 104 comprises a circular-ring-shaped yoke and teeth, which protrude radially inward from an inner circumferential surface of the yoke. The stator core 104 is disposed radially outward of (surrounding) the rotor 102. The stator core 104 comprises a plurality of laminated steel sheets. Each of the steel sheets is a sheet made of a metal in which iron is the main component. The stator core 104 has a tube shape. The teeth of the stator core 104 respectively support the coils 105. In the present embodiment, six teeth are provided.

The coils 105 are mounted on the stator core 104 via (around) the insulator 112. The coils 105 are respectively wound around the teeth of the stator core 104 via (around) the insulator 112. The insulator 112 is an electrically insulating member that is made of a synthetic resin (polymer). The coils 105 and the stator core 104 are electrically insulated from each other by the insulator 112. Pairs of the coils 105 are electrically connected to each other via respective busbars and terminals 106 (fusing terminals). In the present embodiment, six of the coils 105 are provided. Two of the coils 105 serve as U-phase coils, two of the coils 105 serve as V-phase coils, and two of the coils 105 serve as W-phase coils. Three of the terminals 106 are provided. The first terminal 106 electrically connects the pair of U-phase coils. The second terminal 106 electrically connects the pair of V-phase coils. The third terminal 106 electrically connects the pair of W-phase coils. In the present embodiment, the three terminals 106 are disposed at a rear portion of the stator core 104. The three terminals 106 are disposed lined up in the left-right direction.

The rotor 102 comprises a rotor core 107, rotor magnets 108, and a balance-correcting plate 113. The rotor core 107 and the rotor shaft 103 are each made of steel. The rotor shaft 103 is disposed in a through hole that is provided in the center of the rotor core 107. The rotor core 107 and the rotor shaft 103 are fixed to each other. A front portion of the rotor shaft 103 protrudes forward from a front end surface of the rotor core 107. An output pinion 114 is fixed to a front portion of the rotor shaft 103. The rotational force of the rotor shaft 103 is output via the output pinion 114. A rear portion of the rotor shaft 103 protrudes rearward from a rear-end surface of the rotor core 107. The rotor magnets 108 are fixed to the rotor core 107. The rotor magnets 108 are respectively disposed in the interiors of magnet holes provided in the rotor core 107. In the present embodiment, four of the rotor magnets 108 are disposed in the circumferential direction of the rotor core 107. The balance-correcting plate 113 is fixed to the front-end surface of the rotor core 107. The balance-correcting plate 113 is made of brass. The balance-correcting plate 113 corrects the rotational balance of the rotor 102 to improve the rotational balance of the rotor 102.

A sensor board 109 is mounted on the stator 101. The sensor board 109 comprises: a circular-ring-shaped circuit-board part 109A, which opposes the rear-end surface of the rotor core 107; and a support part 109B, which is connected to the upper portion of the stator core 104. Magnetic sensors 110 are disposed on the circuit-board part 109A. At least one portion of the circuit-board part 109A opposes the rotor magnets 108. The magnetic sensors 110 detect the position of the rotor 102 in the rotational direction by detecting the location of the rotor magnets 108 based on magnetic flux.

A fan 111 is fixed to a front-end portion of the rotor shaft 103. When the rotor shaft 103 rotates, the fan 111 rotates together with the rotor shaft 103. The rotation of the fan 111 generates an airflow for cooling the feed motor 100.

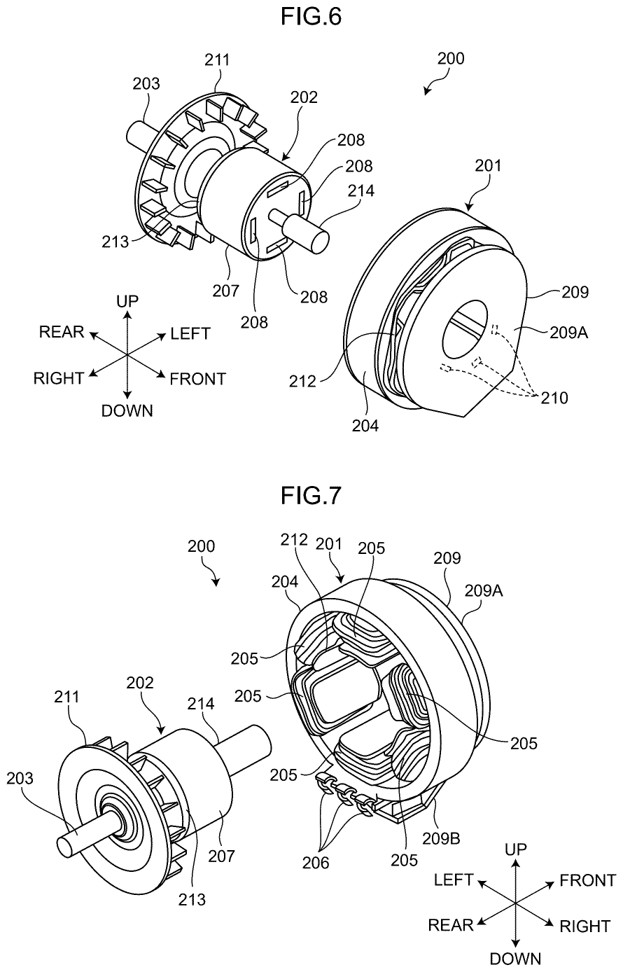

FIG. 6 is an exploded, oblique view, viewed from the upper right and the front, of the twisting motor 200 according to the present embodiment. FIG. 7 is an exploded, oblique view, viewed from the upper right and the rear, of the twisting motor 200 according to the present embodiment. The twisting motor 200 generates a rotational force. The twisting motor 200 is an electric motor. The twisting motor 200 is preferably an inner-rotor-type brushless motor. The twisting motor 200 comprises a stator 201, a rotor 202, and a rotor shaft 203. The stator 201 is disposed around the rotor 202. The rotor 202 is disposed around the rotor shaft 203. The rotor shaft 203 is fixed to the rotor 202. The rotor 202 and the rotor shaft 203 rotate relative to the stator 201. The rotor 202 and the rotor shaft 203 rotate about a rotational axis that extends in the front-rear direction.

The stator 201 comprises a stator core 204, an insulator 212, and coils 205. The stator core 204 comprises a circular-ring-shaped yoke and teeth, which protrude radially inward from an inner circumferential surface of the yoke. The stator core 204 is disposed radially outward of (surrounding) the rotor 202. The stator core 204 comprises a plurality of laminated steel sheets. Each of the steel sheets is a sheet made of a metal in which iron is the main component. The stator core 204 has a tube shape. The teeth of the stator core 204 respectively support the coils 205. In the present embodiment, six teeth are provided.

The coils 205 are mounted on the stator core 204 via (around) the insulator 212. The coils 205 are respectively wound around the teeth of the stator core 204 via (around) the insulator 212. The insulator 212 is an electrically insulating member that is made of a synthetic resin (polymer(. The coils 205 and the stator core 204 are electrically insulated from each other by the insulator 212. Pairs of the coils 205 are electrically connected to each other via respective busbars and terminals 206 (fusing terminals). In the present embodiment, six of the coils 205 are provided. Two of the coils 205 serve as U-phase coils, two of the coils 205 serve as V-phase coils, and two of the coils 205 serve as W-phase coils. Three of the terminals 206 are provided. The first terminal 206 electrically connects the pair of U-phase coils. The second terminal 206 electrically connects the pair of V-phase coils. The third terminal 206 electrically connects the pair of W-phase coils. In the present embodiment, the three terminals 206 are disposed at a lower portion of the stator core 204. The three terminals 206 are disposed lined up in the left-right direction.

The rotor 202 comprises a rotor core 207, rotor magnets 208, and a balance-correcting plate 213. The rotor core 207 and the rotor shaft 203 are each made of steel. The rotor shaft 203 is disposed in a through hole that is provided in the center of the rotor core 207. The rotor core 207 and the rotor shaft 203 are fixed to each other. A front portion of the rotor shaft 203 protrudes forward from a front-end surface of the rotor core 207. An output pinion 214 is fixed to the front portion of the rotor shaft 203. The rotational force of the rotor shaft 203 is output via the output pinion 214. A rear portion of the rotor shaft 203 protrudes rearward from a rear-end surface of the rotor core 207. The rotor magnets 208 are fixed to the rotor core 207. The rotor magnets 208 are respectively disposed in the interiors of magnet holes provided in the rotor core 207. In the present embodiment, four of the rotor magnets 208 are disposed in the circumferential direction of the rotor core 207. The balance-correcting plate 213 is fixed to the rear-end surface of the rotor core 207. The balance-correcting plate 213 is made of brass. The balance-correcting plate 213 corrects the rotational balance of the rotor 202 to improve the rotational balance of the rotor 202.

A sensor board 209 is mounted on the stator 201. The sensor board 209 comprises: a circular-ring-shaped circuit-board part 209A, which opposes the rear-end surface of the rotor core 207; and a support part 209B, which is connected to the lower portion of the stator core 204. Magnetic sensors 210 are disposed on the circuit-board part 209A. At least one portion of the circuit-board part 209A opposes the rotor magnets 208. The magnetic sensors 210 detect the position of the rotor 202 in the rotational direction by detecting the location of the rotor magnets 208 based on magnetic flux.

A fan 211 is fixed to the rear portion of the rotor shaft 203. When the rotor shaft 203 rotates, the fan 211 rotates together with the rotor shaft 203. The rotation of the fan 211 generates an airflow for cooling the twisting motor 200.

### Controller

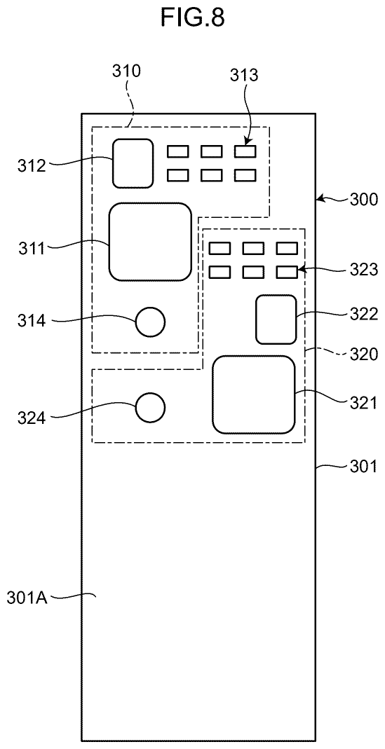

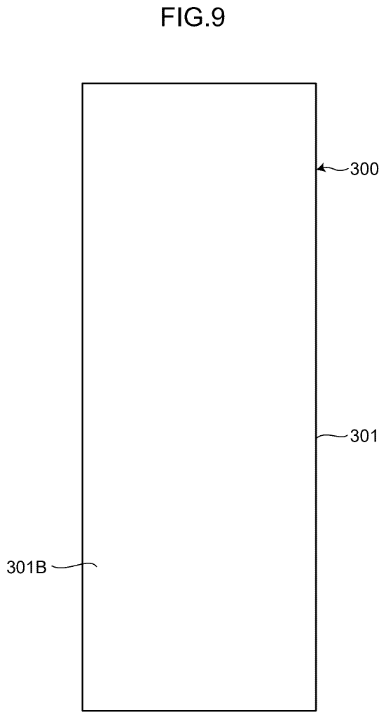

FIG. 8 is a front view that shows the controller 300 according to the present embodiment. FIG. 9 is a rear view that shows the controller 300 according to the present embodiment. The controller 300 comprises: a circuit board 301; a first control circuit 310, which is mounted on the circuit board 301; and a second control circuit 320, which is mounted on the circuit board 301. The first control circuit 310 controls the feed motor 100. The second control circuit 320 controls the twisting motor 200.

The circuit board 301 has an elongated plate shape that is elongated in a prescribed direction. The circuit board 301 has a first surface 301A and a second surface 301B, which faces towards the opposite direction of the first surface 301A. In the present embodiment, the first control circuit 310 and the second control circuit 320 are each mounted on the first surface 301A of the circuit board 301.

The first control circuit 310 comprises a microcomputer 311, a gate-driver circuit 312, an inverter circuit 313, and a capacitor 314. The microcomputer 311 comprises: a processor, such as a CPU (central-processing unit); nonvolatile memory, such as ROM (read-only memory); and volatile memory, such as RAM (random-access memory). The inverter circuit 313 supplies the coils 205 with drive currents based on the electric power supplied from the battery 10. The inverter circuit 313 comprises six switching elements. Each of the switching elements comprises a field-effect transistor (FET). It is noted that the switching elements may be IGBTs or may be MOSFETs. The gate-driver circuit 312 is a drive circuit for driving the switching elements of the inverter circuit 313. The microcomputer 311 outputs control signals to the gate-driver circuit 312 and drives the switching elements of the inverter circuit 313. The capacitor 314 is provided to reduce the noise when switching is performed by the switching elements. In addition, the capacitor 314 is provided to reduce inductance when the battery 10 is mounted on the foot part 8.

The second control circuit 320 comprises a microcomputer 321, a gate-driver circuit 322, an inverter circuit 323, and a capacitor 324. The structure and functions of the microcomputer 321 are substantially the same as the structure and functions of the microcomputer 311. The structure and functions of the gate-driver circuit 322 are substantially the same as the structure and functions of the gate-driver circuit 312. The structure and functions of the inverter circuit 323 are substantially the same as the structure and functions of the inverter circuit 313. The structure and functions of the capacitor 324 are substantially the same as the structure and functions of the capacitor 314. Explanations concerning the microcomputer 321, the gate-driver circuit 322, the inverter circuit 323, and the capacitor 324 are omitted.

### Arrangement of the Controller

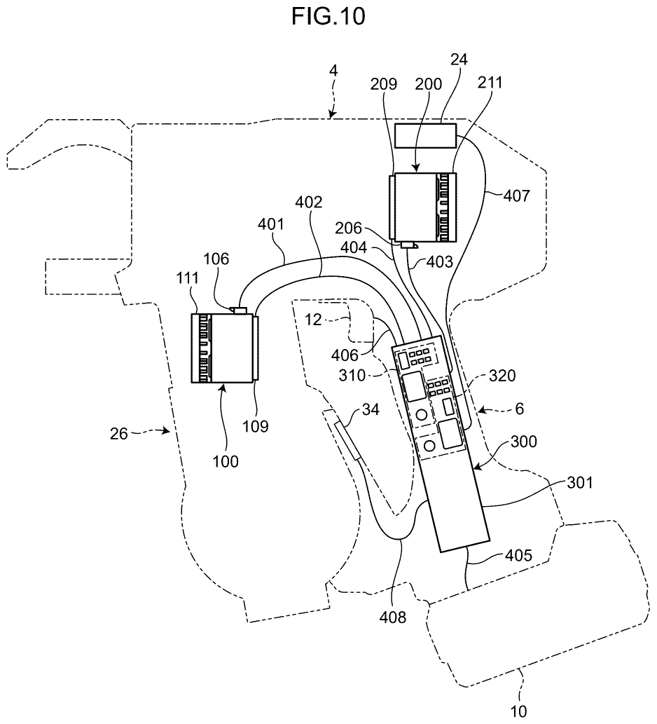

FIG. 10 is a diagram schematically showing a layout example of the controller 300 according to the present embodiment. The controller 300 is disposed in the grip part 6. More specifically, the controller 300 is disposed in the grip part 6 so that the circuit board 301 extends in the up-down direction. The controller 300 is disposed in the grip part 6 so that the first surface 301A of the circuit board 301, on which the first control circuit 310 and the second control circuit 320 are mounted, faces leftward. It is noted that the controller 300 may instead be disposed in the grip part 6 so that the first surface 301A of the circuit board 301 faces rightward.

The feed motor 100 is disposed more forward than the controller 300. The twisting motor 200 is disposed more upward than the controller 300. The feed motor 100 is disposed in the coupling part 26. The twisting motor 200 is disposed in the head part 4. The feed motor 100 is disposed more forward than the twisting motor 200.

The feed motor 100 is disposed so that the rotational axis of the rotor 102 and the rotor shaft 103 extends in the front-rear direction. The fan 111 is disposed more forward than the stator 101. The terminals 106, which respectively connect pairs of the coils of the stator 101, are disposed at an upper portion of the stator 101. The sensor board 109, which detects the rotation of the rotor 102, is disposed more rearward than the stator 101. The terminals 106 and the controller 300 are connected by power cables 401. As described above, three of the terminals 106 are provided. One of the terminals 106 and the controller 300 are connected by one of the power cables 401. Three of the power cables 401 are provided. Five signal cables 402 are provided. The power cables 401 and the signal cables 402 each pass through the head part 4.

The twisting motor 200 is disposed so that the rotational axis of the rotor 202 and the rotor shaft 203 extends in the front-rear direction. The fan 211 is disposed more rearward than the stator 201. The terminals 206, which respectively connect pairs of the coils of the stator 201, are disposed at a lower portion of the stator 201. The sensor board 209, which detects the rotation of the rotor 202, is disposed more forward than the stator 201. The terminals 206 and the controller 300 are connected by power cables 403. As described above, three of the terminals 206 are provided. One of the terminals 206 and the controller 300 are connected by one of the power cables 403. Three of the power cables 403 are provided. Five signal cables 404 are provided.

The controller 300 and the battery terminals of the battery 10 are electrically connected by power-supplying cables 405. Two of the power-supplying cables 405 are provided. Electric power is output from the battery 10 to the controller 300 via the power-supplying cables 405.

The controller 300 and the trigger 12 are electrically connected by a signal cable 406. One signal cable 406 is provided. The manipulation signal, which is generated when the trigger 12 is manipulated, is transmitted to the controller 300 via the signal cable 406.

The first operation-and-indicator part 24 is disposed on the head part 4. The controller 300 and the first operation-and-indicator part 24 are electrically connected by a plurality of signal cables 407. The first signal cable 407 electrically connects the controller 300 and the manipulable parts of the first operation-and-indicator part 24. The second signal cable 407 electrically connects the controller 300 and the indicator parts of the first operation-and-indicator part 24. A manipulation signal, which is generated by manipulation of the manipulable parts of the first operation-and-indicator part 24, is transmitted to the controller 300 via the first signal cable 407. An indicator instruction signal, which is generated in the controller 300, is transmitted to the indicator parts of the first operation-and-indicator part 24 via the second signal cable 407.

The second operation-and-indicator part 34 is disposed on the coupling part 26. The controller 300 and the second operation-and-indicator part 34 are electrically connected by a plurality of signal cables 408. The first signal cable 408 electrically connects the controller 300 and the manipulable part of the second operation-and-indicator part 34. The second signal cable 408 electrically connects the controller 300 and the indicator part of the second operation-and-indicator part 34. The manipulation signal, which is generated by manipulation of the manipulable part of the second operation-and-indicator part 34, is transmitted to the controller 300 via the first signal cable 408. The indicator instruction signal, which is generated in the controller 300, is transmitted to the indicator part of the second operation-and-indicator part 34 via the second signal cable 408.

The first control circuit 310 supplies the terminals 106 with electric power from the battery 10 via the power cables 401. The electric power supplied to the terminals 106 is supplied to the coils of the feed motor 100. The rotor 102 of the feed motor 100 rotates owing to the electric power being supplied to the coils of the feed motor 100. The detection signal of the sensor board 109, which detects rotation of the rotor 102, is input into the first control circuit 310 via the signal cables 402. The first control circuit 310 controls the electric power supplied to the coils of the feed motor 100 based on the detection signal from the sensor board 109.

The second control circuit 320 supplies the terminals 206 with electric power from the battery 10 via the power cables 403. The electric power supplied to the terminals 206 is supplied to the coils of the twisting motor 200. The rotor 202 of the twisting motor 200 rotates owing to the electric power being supplied to the coils of the twisting motor 200. The detection signal of the sensor board 209, which detects rotation of the rotor 202, is input into the second control circuit 320 via the signal cables 404. The second control circuit 320 controls the electric power supplied to the coils of the twisting motor 200 based on the detection signal from the sensor board 209.

### Functions and Effects

As described above, in the first embodiment, the rebar-tying tool 2 comprises: the feed motor 100, which is the first brushless motor that feeds the wire wound around the reel 33; the twisting motor 200, which is the second brushless motor that twists the wire; the head part 4, in which the twisting motor 200 is disposed; the grip part 6, which extends downward from the head part 4; the foot part 8, which is disposed downward of the grip part 6 and to which the battery 10 is connected; the coupling part 26, which is disposed forward of the grip part 6, couples the head part 4 and the foot part 8, and in which the reel 33 and the feed motor 100 are disposed; and the controller 300, which controls the feed motor 100 and the twisting motor 200. The controller 300 is disposed in the grip part 6.

In the above-mentioned configuration, the controller 300 is disposed at a suitable location in the rebar-tying tool 2.

In the embodiment, the power cables 401—which are the first cables that electrically connect the feed motor 100 (the first brushless motor) and the controller 300—and the signal cables 402 pass through the head part 4.

In the above-mentioned configuration, the feed motor 100, the controller 300, the power cables 401, and the signal cables 402 are disposed at suitable locations in the rebar-tying tool 2.

In the first embodiment, the rebar-tying tool 2 comprises the first operation-and-indicator part 24, which is disposed on the head part 4. The first operation-and-indicator part 24 and the controller 300 are electrically connected by the signal cables 407, which are the second cables.

In the above-mentioned configuration, the first operation-and-indicator part 24, the controller 300, and the signal cables 407 are disposed in a suitable positional relationship in the rebar-tying tool 2.

In the first embodiment, the feed motor 100, which is the first brushless motor, comprises: the stator 101, which is the first stator; and the rotor 102, which is the first rotor and is disposed in the interior of the stator 101. The feed motor 100 is disposed so that the rotational axis of the rotor 102 extends in the front-rear direction. The terminals 106, which are the first terminals that electrically connect pairs of the coils 105 of the stator 101, are disposed at an upper portion of the stator 101. The sensor board 109, which is the first sensor board and detects the rotation of the rotor 102, is disposed more rearward than the stator 101. The terminals 106 and the controller 300 are electrically connected by the power cables 401, which are the first power cables. The sensor board 109 and the controller 300 are electrically connected by the signal cables 402, which are the first signal cables.

In the above-mentioned configuration, the feed motor 100 and the controller 300 are disposed in a suitable positional relationship.

In the embodiment, the twisting motor 200, which is the second brushless motor, comprises: the stator 201, which is the second stator; and the rotor 202, which is the second rotor and is disposed in the interior of the stator 201. The twisting motor 200 is disposed so that the rotational axis of the rotor 202 extends in the front-rear direction. The terminals 206, which are the second terminals that electrically connect pairs of the coils 205 of the stator 201, are disposed at a lower portion of the stator 201. The sensor board 209, which is the second sensor board and detects the rotation of the rotor 202, is disposed more forward than the stator 201. The terminals 206 and the controller 300 are electrically connected by the power cables 403, which are the second power cables. The sensor board 209 and the controller 300 are electrically connected by the signal cables 404, which are the second signal cables.

In the above-mentioned configuration, the second brushless motor and the controller are disposed in a suitable positional relationship.

### Second Embodiment

A second embodiment will be described. In the explanation below, structural elements that are identical or equivalent to those in the embodiment described above are assigned the same reference numerals, and descriptions of those structural elements are simplified or omitted.

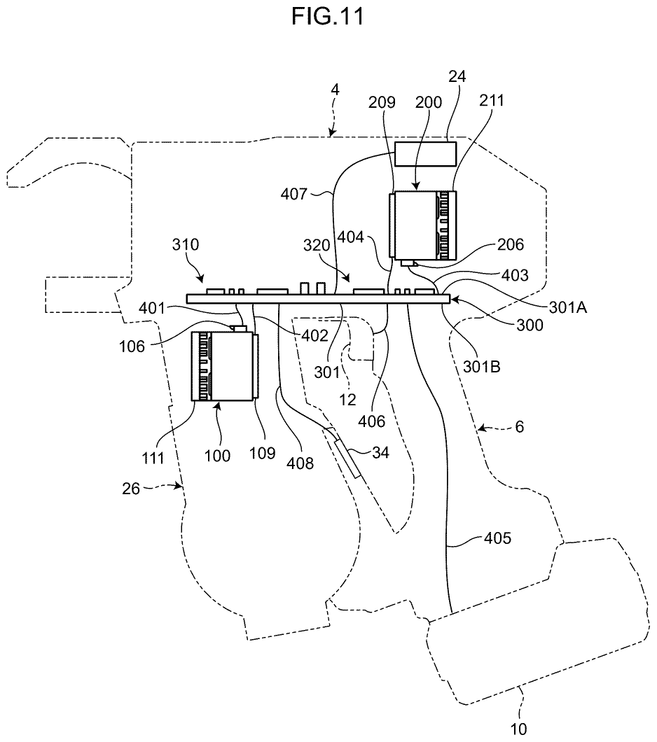

FIG. 11 is a diagram schematically showing a layout example of the controller 300 according to the present embodiment. In the example shown in FIG. 11, the controller 300 is disposed in the head part 4. The controller 300 is disposed between the feed motor 100 and the twisting motor 200 in the up-down direction. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces upward.

The first control circuit 310, which comprises the gate-driver circuit 312 and the inverter circuit 313 for controlling the feed motor 100, is mounted on the forward side of the circuit board 301. The second control circuit 320, which comprises the gate-driver circuit 322 and the inverter circuit 323 for controlling the twisting motor 200, is mounted on the rearward side of the circuit board 301.

The second surface 301B of the circuit board 301 and the feed motor 100 are electrically connected by the power cables 401, and the second surface 301B of the circuit board 301 and the sensor board 109 are electrically connected by the signal cables 402. The first surface 301A of the circuit board 301 and the twisting motor 200 are electrically connected by the power cables 403, and the first surface 301A of the circuit board 301 and the sensor board 209 are electrically connected by the signal cables 404.

As described above, the controller 300 is disposed between the feed motor 100 and the twisting motor 200 in the up-down direction. In addition, the second surface 301B of the circuit board 301 and the feed motor 100 are electrically connected by the power cables 401, and the second surface 301B of the circuit board 301 and the sensor board 109 are electrically connected by the signal cables 402. The first surface 301A of the circuit board 301 and the twisting motor 200 are electrically connected by the power cables 403, and the first surface 301A of the circuit board 301 and the sensor board 209 are electrically connected by the signal cables 404. In addition, in the state in which the twisting motor 200 is disposed more rearward than the feed motor 100, the first control circuit 310, which is for controlling the feed motor 100, is mounted on the forward side of the circuit board 301, and the second control circuit 320, which is for controlling the twisting motor 200, is mounted on the rearward side of the circuit board 301. Thereby, the lengths of the power cables 401, the signal cables 402, the power cables 403, and the signal cables 404 can each be made shorter.

In the second embodiment, the feed motor 100, which is the first brushless motor, and the controller 300 are electrically connected by the power cables 401, which are the first cables, and the signal cables 402. The power cables 401 and the signal cables 402 are electrically connected to the second surface 301B, which is a lower surface of the circuit board 301 of the controller 300.

In the above-mentioned configuration, the feed motor 100, the controller 300, the power cables 401, and the signal cables 402 are disposed in a suitable positional relationship.

In the second embodiment, the rebar-tying tool 2 comprises the first operation-and-indicator part 24, which is disposed on the head part 4. The first operation-and-indicator part 24 and the controller 300 are connected by the signal cables 407, which are the second cables. The signal cables 407 are connected to the first surface 301A, which is an upper surface of the circuit board 301 of the controller 300.

In the above-mentioned configuration, the first operation-and-indicator part 24, the controller 300, and the signal cables 407 are disposed at suitable locations in the rebar-tying tool 2.

In the second embodiment, the feed motor 100, which is the first brushless motor, comprises: the stator 101, which is the first stator; and the rotor 102, which is the first rotor and is disposed in the interior of the stator 101. The feed motor 100 is disposed so that the rotational axis of the rotor 102 extends in the front-rear direction. The terminals 106, which are the first terminals that electrically connect pairs of the coils 105 of the stator 101, are disposed at an upper portion of the stator 101. The sensor board 109, which is the first sensor board and detects the rotation of the rotor 102, is disposed more rearward than the stator 101. The terminals 106 and the controller 300 are connected by the power cables 401, which are the first power cables. The sensor board 109 and the controller 300 are connected by the signal cables 402, which are the first signal cables.

In the above-mentioned configuration, the feed motor 100 and the controller 300 are disposed in a suitable positional relationship.

In the embodiment, the twisting motor 200, which is the second brushless motor, comprises: the stator 201, which is the second stator; and the rotor 202, which is the second rotor and is disposed in the interior of the stator 201. The twisting motor 200 is disposed so that the rotational axis of the rotor 202 extends in the front-rear direction. The terminals 206, which are the second terminals that electrically connect pairs of the coils 205 of the stator 201, are disposed at a lower portion of the stator 201. The sensor board 209, which is the second sensor board and detects the rotation of the rotor 202, is disposed more forward than the stator 201. The terminals 206 and the controller 300 are electrically connected by the power cables 403, which are the second power cables. The sensor board 209 and the controller 300 are electrically connected by the signal cables 404, which are the second signal cables.

In the above-mentioned configuration, the twisting motor 200 and the controller 300 are disposed in a suitable positional relationship.

### Third Embodiment

A third embodiment will be described. In the explanation below, structural elements that are identical or equivalent to those in the embodiments described above are assigned the same reference numerals, and descriptions of those structural elements are simplified or omitted.

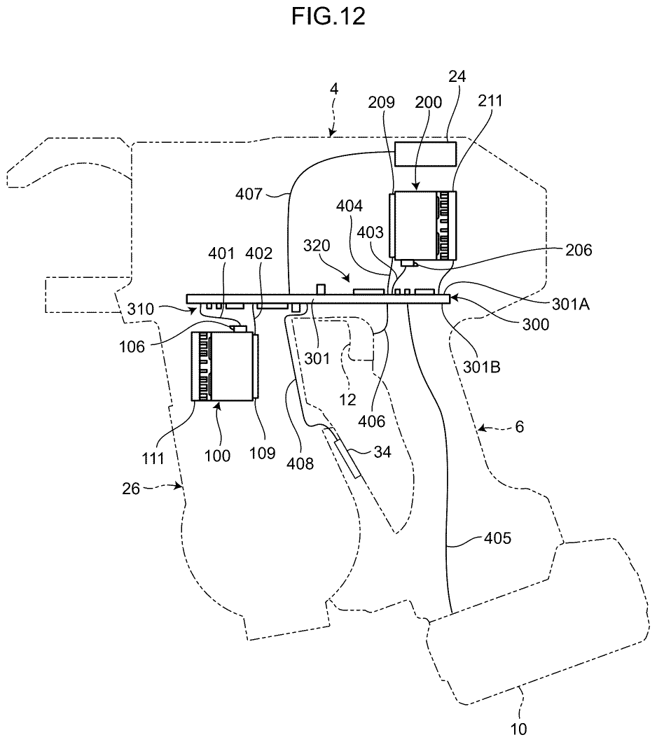

FIG. 12 is a diagram schematically showing a layout example of the controller 300 according to the present embodiment. In the example shown in FIG. 12, the controller 300 is disposed in the head part 4. The controller 300 is disposed between the feed motor 100 and the twisting motor 200 in the up-down direction. The controller 300 is disposed in the head part 4 so that the circuit board 301 extends in the front-rear direction. The first control circuit 310 is mounted on the second surface 301B of the circuit board 301, and the second control circuit 320 is mounted on the first surface 301A of the circuit board 301. The controller 300 is disposed in the head part 4 so that the first surface 301A of the circuit board 301 faces upward.

The first control circuit 310, which comprises the gate-driver circuit 312 and the inverter circuit 313 for controlling the feed motor 100, is mounted on the forward side of the circuit board 301. The second control circuit 320, which comprises the gate-driver circuit 322 and the inverter circuit 323 for controlling the twisting motor 200, is mounted on the rearward side of the circuit board 301.

The second surface 301B of the circuit board 301 and the feed motor 100 are electrically connected by the power cables 401, and the second surface 301B of the circuit board 301 and the sensor board 109 are electrically connected by the signal cables 402. The first surface 301A of the circuit board 301 and the twisting motor 200 are electrically connected by the power cables 403, and the first surface 301A of the circuit board 301 and the sensor board 209 are electrically connected by the signal cables 404.

As described above, the controller 300 is disposed between the feed motor 100 and the twisting motor 200 in the up-down direction. In addition, the second surface 301B of the circuit board 301 and the feed motor 100 are electrically connected by the power cables 401, and the second surface 301B of the circuit board 301 and the sensor board 109 are electrically connected by the signal cables 402. The first surface 301A of the circuit board 301 and the twisting motor 200 are electrically connected by the power cables 403, and the first surface 301A of the circuit board 301 and the sensor board 209 are electrically connected by the signal cables 404. In addition, in the state in which the twisting motor 200 is disposed more rearward than the feed motor 100, the first control circuit 310, which is for controlling the feed motor 100, is mounted on the forward side of the circuit board 301, and the second control circuit 320, which is for controlling the twisting motor 200, is mounted on the rearward side of the circuit board 301. Thereby, the lengths of the power cables 401, the signal cables 402, the power cables 403, and the signal cables 404 can each be made shorter.

In the third embodiment, the controller 300 is disposed in the head part 4.

In the above-mentioned configuration, the controller 300 is disposed at a suitable location in the rebar-tying tool 2.

In the third embodiment, the rebar-tying tool 2 comprises the first operation-and-indicator part 24, which is disposed on the head part 4. A first surface 301A of the circuit board 301 and the first operation-and-indicator part 24 are electrically connected by the signal cables 407.

In the above-mentioned configuration, the first operation-and-indicator part 24, the controller 300, and the signal cables 407 are disposed in a suitable positional relationship in the rebar-tying tool 2.

In the third embodiment, the feed motor 100, which is the first brushless motor, comprises: the stator 101, which is the first stator; and the rotor 102, which is the first rotor and is disposed in the interior of the stator 101. The feed motor 100 is disposed so that the rotational axis of the rotor 102 extends in the front-rear direction. The terminals 106, which are the first terminals that electrically connect pairs of the coils 105 of the stator 101, are disposed at an upper portion of the stator 101. The sensor board 109, which is the first sensor board and detects the rotation of the rotor 102, is disposed more rearward than the stator 101. The terminals 106 and the controller 300 are electrically connected by the power cables 401, which are the first power cables. The sensor board 109 and the controller 300 are electrically connected by the signal cables 402, which are the first signal cables.

In the above-mentioned configuration, the feed motor 100 and the controller 300 are disposed in a suitable positional relationship.

In the third embodiment, the twisting motor 200, which is the second brushless motor, comprises: the stator 201, which is the second stator; and the rotor 202, which is the second rotor and is disposed in the interior of the stator 201. The twisting motor 200 is disposed so that the rotational axis of the rotor 202 extends in the front-rear direction. The terminals 206, which are the second terminals that electrically connect pairs of the coils 205 of the stator 201, are disposed at a lower portion of the stator 201. The sensor board 209, which is the second sensor board and detects the rotation of the rotor 202, is disposed more forward than the stator 201. The terminals 206 and the controller 300 are electrically connected by the power cables 403, which are the second power cables. The sensor board 209 and the controller 300 are electrically connected by the signal cables 404, which are the second signal cables.

In the above-mentioned configuration, the twisting motor 200 and the controller 300 are disposed in a suitable positional relationship.

### Fourth Embodiment

A fourth embodiment will be described. In the explanation below, structural elements that are identical or equivalent to those in the embodiments described above are assigned the same reference numerals, and descriptions of those structural elements are simplified or omitted.

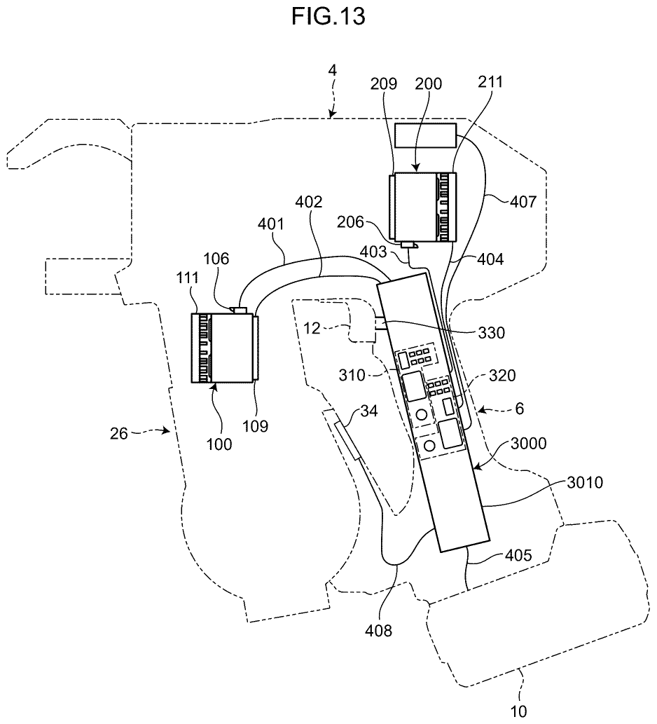

FIG. 13 is a diagram schematically showing a layout example of a controller 3000 according to the present embodiment. In the example shown in FIG. 13, the controller 3000 is disposed in the grip part 6. A circuit board 3010 of the controller 3000 comprises a holding part 330, which holds the trigger 12. The trigger 12 is held directly by the circuit board 3010 of the controller 3000 via the holding part 330. The controller 3000 is an integrated controller that is integrated with the trigger 12. In the embodiment, the signal cable 406 is omitted.

### Fifth Embodiment

A fifth embodiment will be described. In the explanation below, structural elements that are identical or equivalent to those in the embodiments described above are assigned the same reference numerals, and descriptions of those structural elements are simplified or omitted.

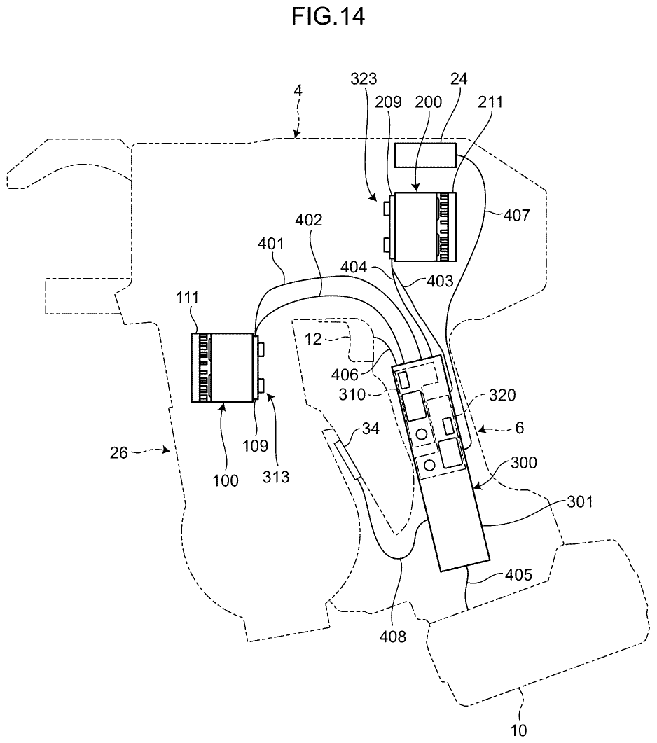

FIG. 14 is a diagram schematically showing a layout example of the controller 300 according to the present embodiment. In the fifth embodiment, at least one of the feed motor 100 (first brushless motor) and the twisting motor 200 (second brushless motor) comprises a sensor board for detecting the rotation of the rotor, and the sensor board further comprises an inverter circuit for driving the motor. FIG. 14 shows an example in which inverter circuits 313, 323 are provided on the sensor board 109 of the feed motor 100 and on the sensor board 209 of the twisting motor 200, respectively.

In the example shown in FIG. 14, the controller 300 is disposed in the grip part 6. The controller 300 is electrically connected to the sensor board 109 of the feed motor 100 by both the power cables 401 and the signal cables 402. The controller 300 is electrically connected to the stator 101 of the feed motor 100 via the sensor board 109. The controller 300 is electrically connected to the sensor board 209 of the twisting motor 200 by both the power cables 403 and the signal cables 404. The controller 300 is electrically connected to the stator 201 of the twisting motor 200 via the sensor board 209.

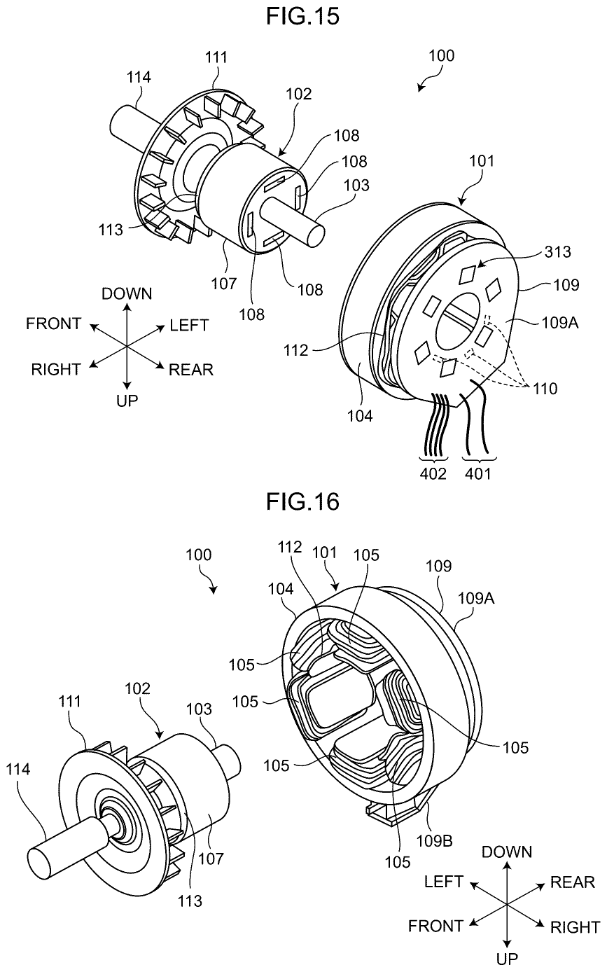

FIG. 15 is an exploded, oblique view, viewed from the rear right and below, of the feed motor 100 according to the present embodiment. FIG. 16 is an exploded, oblique view, viewed from the front right and below, of the feed motor 100 according to the present embodiment.

The sensor board 109 is mounted on the stator 101. The inverter circuit 313, in addition to the magnetic sensors 110, is provided on the circuit-board part 109A of the sensor board 109. The inverter circuit 313 is provided on a rearward surface of the sensor board 109. The inverter circuit 313 comprises six switching elements, which control the supply of electric current to each of the U-phase coils, the V-phase coils, and the W-phase coils. The inverter circuit 313 is electrically connected to the controller 300 (the gate-driver circuit 312) via the power cables 401 and the signal cables 402, which are electrically connected to the sensor board 109. The inverter circuit 313 is electrically connected from the sensor board 109 to each of the coils 105 (U-phase coils, V-phase coils, and W-phase coils) of the stator 101 by wiring (not shown). Consequently, in the examples shown in FIG. 15 and FIG. 16, the terminals 106 (see FIG. 5), which are for supplying electrical power to each of the coils 105, are not provided.

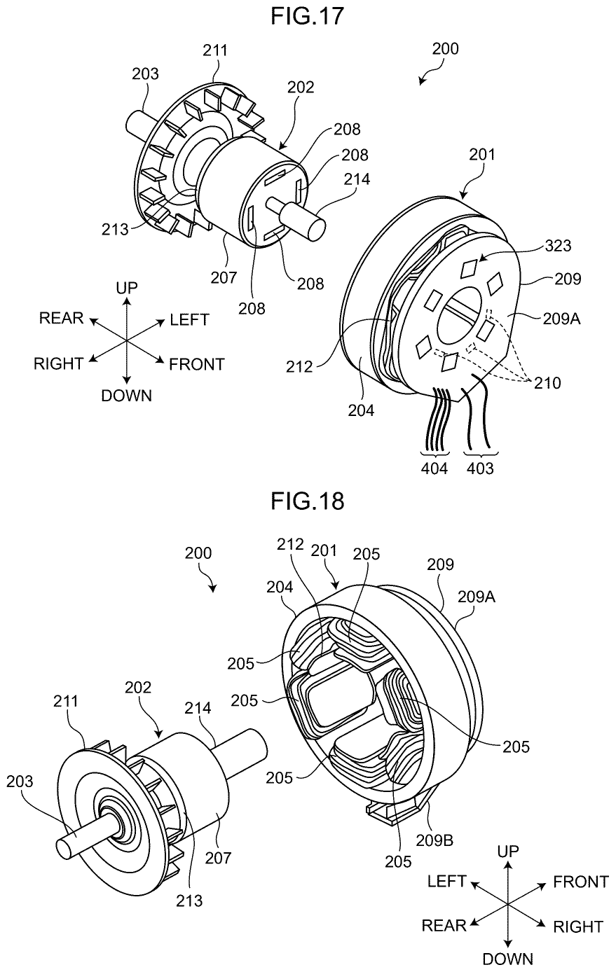

FIG. 17 is an exploded, oblique view, viewed from the upper right and the front, of the twisting motor 200 according to the present embodiment. FIG. 18 is an exploded, oblique view, viewed from the upper right and the rear, of the twisting motor 200 according to the present embodiment.

The sensor board 209 is mounted on the stator 201. The inverter circuit 323, in addition to the magnetic sensors 210, is provided on the circuit-board part 209A of the sensor board 209. The inverter circuit 323 is provided on a forward surface of the sensor board 209. The inverter circuit 323 comprises six switching elements, which control the supply of electric current to each of the U-phase coils, the V-phase coils, and the W-phase coils. The inverter circuit 323 is electrically connected to the controller 300 (the gate-driver circuit 322) via the power cables 403 and the signal cables 404, which are electrically connected to the sensor board 209. The inverter circuit 323 is electrically connected from the sensor board 209 to each of the coils 205 (U-phase coils, V-phase coils, and W-phase coils) of the stator 201 by wiring (not shown). Consequently, in the examples shown in FIG. 17 and FIG. 18, the terminals 206 (see FIG. 7), which are for feeding electrical power to each of the coils 205, are not provided.

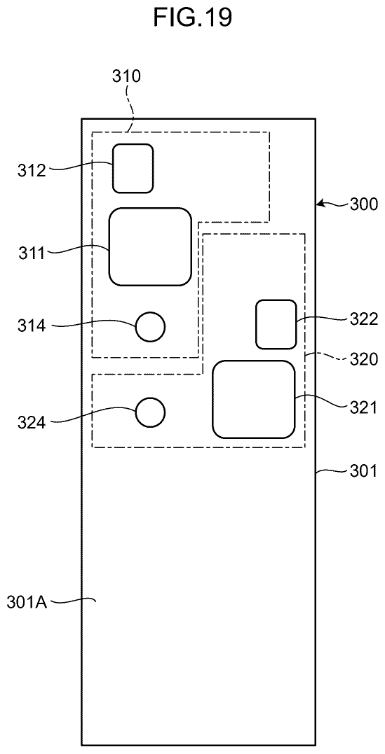

FIG. 19 is a front view that shows the controller 300 according to the present embodiment. The controller 300 comprises: the first control circuit 310, which controls the feed motor 100; and the second control circuit 320, which controls the twisting motor 200. The first control circuit 310 and the second control circuit 320 are each mounted on the first surface 301A of the circuit board 301.

The first control circuit 310 comprises the microcomputer 311, the gate-driver circuit 312, and the capacitor 314. In the present embodiment, the controller 300 (the first control circuit 310) is not provided with the inverter circuit 313 because the inverter circuit 313 is provided on the sensor board 109. The gate-driver circuit 312 drives the inverter circuit 313 of the sensor board 109 via the signal cables 402.

The second control circuit 320 comprises the microcomputer 321, the gate-driver circuit 322, and the capacitor 324. In the present embodiment, the controller 300 (the second control circuit 320) is not provided with the inverter circuit 323 because the inverter circuit 323 is provided on the sensor board 209. The gate-driver circuit 322 drives the inverter circuit 323 of the sensor board 209 via the signal cables 404.

It is noted that, in the fifth embodiment, although the inverter circuit 313 and the inverter circuit 323 for driving the motor are provided on the sensor board 109 of the feed motor 100 (the first brushless motor) and on the sensor board 209 of the twisting motor 200 (the second brushless motor), respectively, the inverter circuits may be provided on only one of the sensor boards. One portion of the inverter circuits may be provided on the controller 300.

As explained above, the controller 300 is disposed in the grip part 6. Thereby, the controller 300 is disposed at a suitable location in the rebar-tying tool 2.

In the embodiment, the feed motor 100, which is the first brushless motor, comprises the sensor board 109, which is the first sensor board for detecting the rotation of the rotor 102. The sensor board 109 comprises the inverter circuit 313 for driving the motor. Thereby, the connections for the power cables 401, which supply drive current to the feed motor 100, and the signal cables 402, which transmit signals to the feed motor 100, can be aggregated on the sensor board 109. Terminals for electrically connecting the power cables 401 to the feed motor 100 do not need to be provided. Because constraints on the arrangement that accompany the wiring process no longer tend to have an impact, the degrees of freedom in the arrangement of the controller 300 increase.

In the fifth embodiment, the twisting motor 200, which is the second brushless motor, comprises the sensor board 209, which is the second sensor board for detecting the rotation of the rotor 202. The sensor board 209 comprises the inverter circuit 323 for driving the motor. Thereby, the connections for the power cables 403, which supply drive current to the twisting motor 200, and the signal cables 404, which transmit signals to the twisting motor 200, can be aggregated on the sensor board 209. Terminals for electrically connecting the power cables 403 to the twisting motor 200 do not need to be provided. Because constraints on the arrangement that accompany the wiring process no longer tend to have an impact, the degrees of freedom in the arrangement of the controller 300 increase.

### Sixth Embodiment

A sixth embodiment will be described. In the explanation below, structural elements that are identical or equivalent to those in the embodiments described above are assigned the same reference numerals, and descriptions of those structural elements are simplified or omitted.

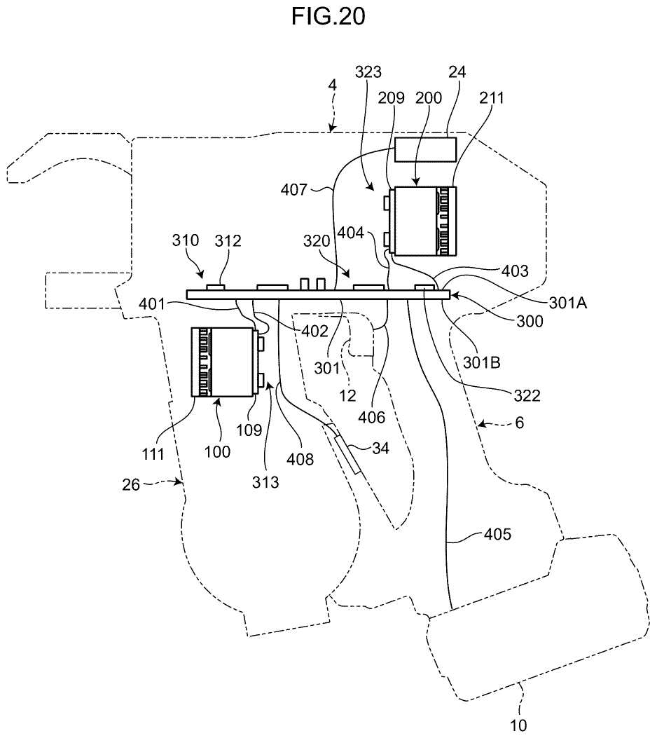

FIG. 20 is a diagram schematically showing a layout example of the controller 300 according to the present embodiment. In the example shown in FIG. 20, the controller 300 is disposed in the head part 4. The controller 300 is disposed between the feed motor 100 and the twisting motor 200 in the up-down direction. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces upward.

The sensor board 109 is disposed more rearward than the stator 101 of the feed motor 100. The first control circuit 310, which comprises the gate-driver circuit 312 for controlling the feed motor 100, is mounted on the forward side of the circuit board 301. That is, the first control circuit 310 is disposed at a location on the circuit board 301 that is on the sensor board 109 side. The sensor board 109 is disposed downward of the first control circuit 310. The inverter circuit 313, which is for controlling the feed motor 100, is provided on the sensor board 109. Consequently, the inverter circuit 313 is not provided on the first control circuit 310.

The sensor board 209 is disposed more forward than the stator 201 of the twisting motor 200. The second control circuit 320, which comprises the gate-driver circuit 322 for controlling the twisting motor 200, is mounted on the rearward side of the circuit board 301. That is, the second control circuit 320 is disposed at a location on the circuit board 301 that is proximate to the sensor board 209. The sensor board 209 is disposed upward of the second control circuit 320. The inverter circuit 323, which is for controlling the twisting motor 200, is provided on the sensor board 209. Consequently, the inverter circuit 323 is not provided on the second control circuit 320.

The second surface 301B of the circuit board 301 and the sensor board 109 are connected by the power cables 401 and the signal cables 402. The sensor board 109 and the stator 101 are electrically connected by wiring. The inverter circuit 313 is driven by the gate-driver circuit 312 to thereby supply electric power from the power cables 401 to each of the coils 105 (the U-phase coils, V-phase coils, and W-phase coils) of the feed motor 100. The first surface 301A of the circuit board 301 and the sensor board 209 are electrically connected by the power cables 403 and the signal cables 404. The sensor board 209 and the stator 201 are connected by wiring. The inverter circuit 323 is driven by the gate-driver circuit 322 to thereby supply electric power from the power cables 403 to each of the coils 205 (the U-phase coils, V-phase coils, and W-phase coils) of the twisting motor 200.

As described above, the controller 300 is disposed between the feed motor 100 and the twisting motor 200 in the up-down direction. In addition, the inverter circuit 313, which is for controlling the feed motor 100, is provided on the sensor board 109. The inverter circuit 323, which is for controlling the twisting motor 200, is provided on the sensor board 209. In addition, the second surface 301B of the circuit board 301 and the sensor board 109 of the feed motor 100 are electrically connected by the power cables 401 and the signal cables 402. The first surface 301A of the circuit board 301 and the sensor board 209 of the twisting motor 200 are electrically connected by the power cables 403 and the signal cables 404. In addition, the first control circuit 310, which is for controlling the feed motor 100, is mounted at a location on the circuit board 301 that is proximate to the sensor board 109. The second control circuit 320, which is for controlling the twisting motor 200, is mounted at a location on the circuit board 301 that is proximate to the sensor board 209. Thereby, the lengths of the power cables 401, the signal cables 402, the power cables 403, and the signal cables 404 can each be made shorter.

### Seventh Embodiment

A seventh embodiment will be described. In the explanation below, structural elements that are identical or equivalent to those in the embodiments described above are assigned the same reference numerals, and descriptions of those structural elements are simplified or omitted.

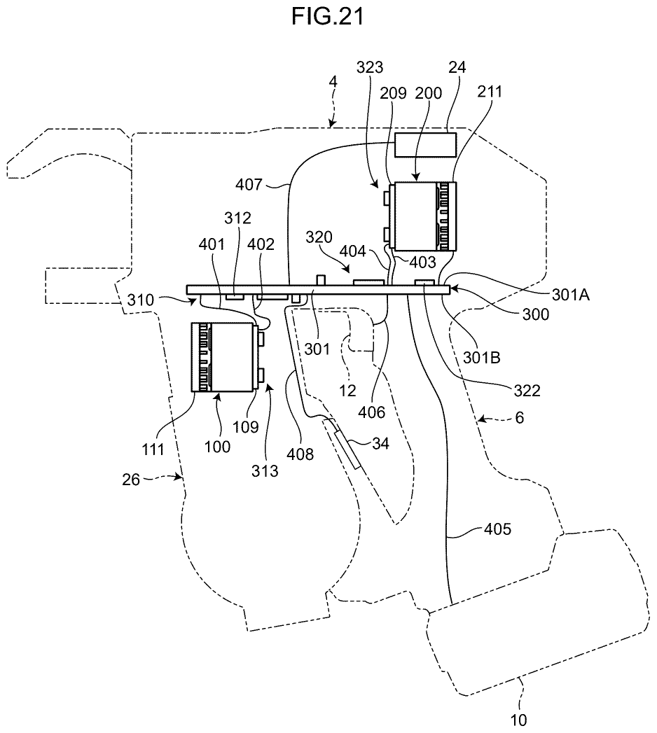

FIG. 21 is a diagram schematically showing a layout example of the controller 300 according to the present embodiment. In the example shown in FIG. 21, the controller 300 is disposed in the head part 4. The controller 300 is disposed between the feed motor 100 and the twisting motor 200 in the up-down direction. The controller 300 is disposed in the head part 4 so that the circuit board 301 extends in the front-rear direction. The first control circuit 310 is mounted on the second surface 301B of the circuit board 301, and the second control circuit 320 is mounted on the first surface 301A of the circuit board 301. The controller 300 is disposed in the head part 4 so that the first surface 301A of the circuit board 301 faces upward.

The sensor board 109 is disposed more rearward than the stator 101 of the feed motor 100. The first control circuit 310, which comprises the gate-driver circuit 312 for controlling the feed motor 100, is mounted on the forward side of the circuit board 301. The first control circuit 310 is disposed at a location more proximate to the sensor board 109 than to the second control circuit 320. The sensor board 109 is disposed downward of the first control circuit 310, and the sensor board 109 and the first control circuit 310 are lined up vertically. The inverter circuit 313, which is for controlling the feed motor 100, is provided on the sensor board 109. Consequently, the inverter circuit 313 is not provided on the first control circuit 310.

The sensor board 209 is disposed more forward than the stator 201 of the twisting motor 200. The second control circuit 320, which comprises the gate-driver circuit 322 for controlling the twisting motor 200, is mounted on the rearward side of the circuit board 301. The second control circuit 320 is disposed at a location more proximate to the sensor board 209 than to the first control circuit 310. The sensor board 209 is disposed upward of the second control circuit 320, and the sensor board 209 and the second control circuit 320 are lined up vertically. The inverter circuit 323, which is for controlling the twisting motor 200, is provided on the sensor board 209. Consequently, the inverter circuit 323 is not provided on the second control circuit 320.

The second surface 301B of the circuit board 301 and the sensor board 109 are electrically connected by the power cables 401 and the signal cables 402. The first surface 301A of the circuit board 301 and the sensor board 209 are electrically connected by the power cables 403 and the signal cables 404.

As described above, the controller 300 is disposed between the feed motor 100 and the twisting motor 200 in the up-down direction. In addition, the inverter circuit 313, which is for controlling the feed motor 100, is provided on the sensor board 109. The inverter circuit 323, which is for controlling the twisting motor 200, is provided on the sensor board 209. In addition, the first surface 301A of the circuit board 301 and the sensor board 109 are electrically connected by the power cables 401 and the signal cables 402. The second surface 301B of the circuit board 301 and the sensor board 209 are electrically connected by the power cables 403 and the signal cables 404. In addition, the first control circuit 310, which is for controlling the feed motor 100, is mounted at a location more proximate to the sensor board 109 than to the second control circuit 320. The second control circuit 320, which is for controlling the twisting motor 200, is mounted at a location more proximate to the sensor board 209 than to the first control circuit 310. Thereby, the lengths of the power cables 401, the signal cables 402, the power cables 403, and the signal cables 404 can each be shortened.

### Eighth Embodiment

An eighth embodiment will be described. In the explanation below, structural elements that are identical or equivalent to those in the embodiments described above are assigned the same reference numerals, and descriptions of those structural elements are simplified or omitted.

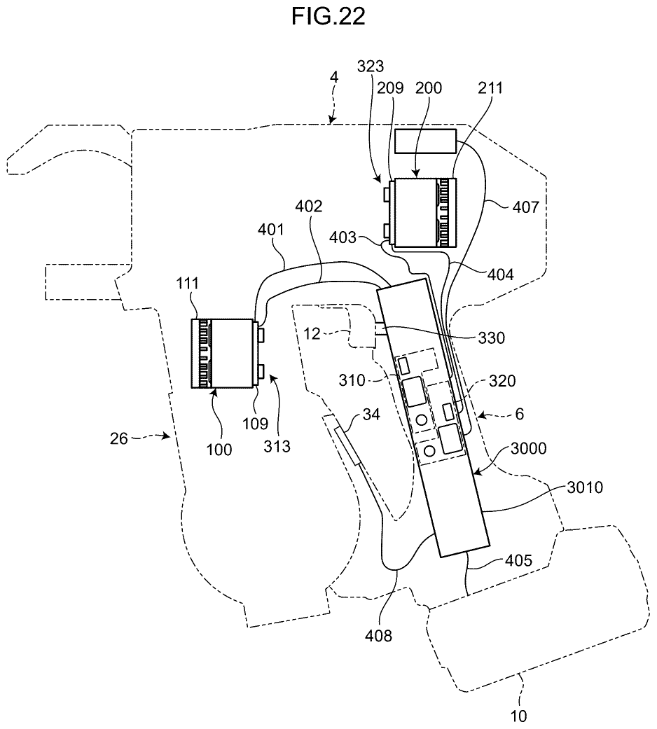

FIG. 22 is a diagram schematically showing a layout example of the controller 3000 according to the present embodiment. In the example shown in FIG. 22, the controller 3000 is disposed in the grip part 6. The circuit board 3010 of the controller 3000 comprises the holding part 330, which holds the trigger 12. The trigger 12 is held directly by the circuit board 3010 of the controller 3000 via the holding part 330. The controller is an integrated controller that is integrated with the trigger 12. In the embodiment, the signal cable 406 is omitted.

The sensor board 109 is disposed on the feed motor 100. The inverter circuit 313, which is for controlling the feed motor 100, is provided on the sensor board 109. Consequently, the inverter circuit 313 is not provided on the first control circuit 310. The sensor board 209 is disposed on the twisting motor 200. The inverter circuit 323, which is for controlling the twisting motor 200, is provided on the sensor board 209. Consequently, the inverter circuit 323 is not provided on the second control circuit 320.

The circuit board 3010 and the sensor board 109 are electrically connected by the power cables 401 and the signal cables 402. The controller 3000 performs drive control of the feed motor 100 via the sensor board 109. The circuit board 3010 and the sensor board 209 are connected by the power cables 403 and the signal cables 404. The controller 3000 performs drive control of the twisting motor 200 via the sensor board 209.

As described above, the inverter circuit 313, which is for controlling the feed motor 100, is provided on the sensor board 109. The inverter circuit 323, which is for controlling the twisting motor 200, is provided on the sensor board 209. Thereby, by providing the inverter circuits 313, 323 on the sensor boards 109, 209, which each detect the rotation of the corresponding rotor, the inverter circuits 313, 323 can be omitted from the circuit board 3010 of the controller 3000. Because constraints on the arrangement that accompany the wiring process no longer tend to have an impact, the degrees of freedom in the arrangement of the controller 300 increase.

### Ninth Embodiment

A ninth embodiment will be described. In the explanation below, structural elements that are identical or equivalent to those in the embodiments described above are assigned the same reference numerals, and descriptions of those structural elements are simplified or omitted.

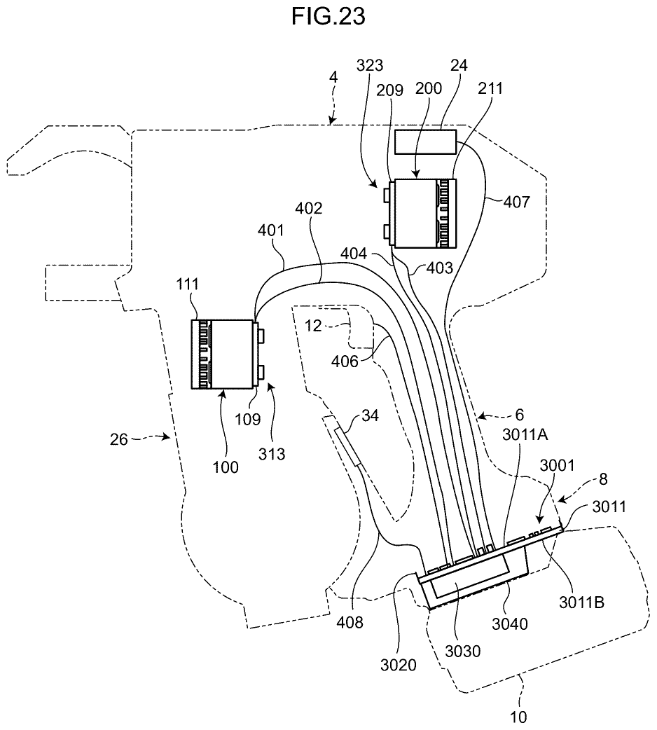

FIG. 23 is a diagram schematically showing a layout example of a controller 3001 according to the present embodiment. The controller 3001 is disposed in the foot part 8. The controller 3001 is disposed in the foot part 8 so that a circuit board 3011 extends in the front-rear direction. The controller 3001 is disposed in the foot part 8 so that a first surface 3011A of the circuit board 3011, on which the first control circuit 310 and the second control circuit 320 are mounted, faces upward.

The sensor board 109 is disposed on the feed motor 100. The inverter circuit 313, which is for controlling the feed motor 100, is provided on the sensor board 109. Consequently, the inverter circuit 313 is not provided on the first control circuit 310. The sensor board 209 is disposed on the twisting motor 200. The inverter circuit 323, which is for controlling the twisting motor 200, is provided on the sensor board 209. Consequently, the inverter circuit 323 is not provided on the second control circuit 320.

The circuit board 3011 and the sensor board 109 are connected by the power cables 401 and the signal cables 402. The controller 3001 performs drive control of the feed motor 100 via the sensor board 109. The circuit board 3011 and the sensor board 209 are electrically connected by the power cables 403 and the signal cables 404. The controller 3001 performs drive control of the twisting motor 200 via the sensor board 209. In addition, the controller 3001 is connected to the trigger 12 via the signal cable 406, is electrically connected to the first operation-and-indicator part 24 via the signal cables 407, and is electrically connected to the second operation-and-indicator part 34 via the signal cables 408.

In the ninth embodiment, the controller 3001 comprises: the circuit board 3011; a controller case 3020, which houses the circuit board 3011; and terminals 3030, which connect the battery 10 and the circuit board 3011. In the ninth embodiment, the controller 3001 (the circuit board 3011) is directly connected to the battery 10 by the terminals 3030. Consequently, in the present embodiment, the power-supplying cables 405 are omitted.

The controller case 3020 is a flat, dish shape or tray shape in which the upper surface is recessed in a concave shape. The controller case 3020 houses the circuit board 3011 in the interior of the recessed portion. The controller case 3020 is housed inside the housing 16. A lower surface of the controller case 3020 constitutes one portion of a connection surface with the battery 10 in the foot part 8. The terminals 3030 are provided on a second surface 3011B of the circuit board 3011. The lower surface of the controller case 3020 causes one portion of each of the terminals 3030 to be exposed so that the terminals 3030 are connectable to the terminals of the battery 10. A guide 3040 may be formed on the lower surface of the controller case 3020. The guide 3040 partially covers the terminals 3030 and protects the terminals from the exterior and also guides the battery 10 when connecting the terminals of the battery to the terminals 3030. The lower surface of the controller case 3020, the terminals 3030, and the guide 3040 are covered by the housing of the battery 10 and are not exposed to the exterior in the state in which the battery 10 is connected.

As described above, in the ninth embodiment, the rebar-tying tool 2 comprises: the feed motor 100, which is the first brushless motor that feeds a wire that is wound around the reel; the twisting motor 200, which is the second brushless motor that twists the wire; the head part 4, in which the twisting motor 200 is disposed; the grip part 6, which extends downward from the head part 4; the foot part 8, which is disposed downward of the grip part 6 and to which the battery 10 is connectable; the coupling part 26, which is disposed forward of the grip part 6, which couples the head part 4 and the foot part 8, and in which the reel 33 and the feed motor 100 are disposed; and the controller 3001, which controls the feed motor 100 and the twisting motor 200; wherein: the controller 3001 is disposed in the foot part 8; and the controller 3001 comprises the circuit board 3011, the controller case 3020, which houses the circuit board 3011, and the terminals 3030, which connect the battery 10 and the circuit board 3011 to each other.

In the above-mentioned configuration, the controller 3001 is disposed at a suitable location in the rebar-tying tool 2. The power-supplying cables 405 can be omitted and the internal structure of the device can be simplified.

### Tenth Embodiment

A tenth embodiment will be described. In the explanation below, structural elements that are identical or equivalent to those in the embodiments described above are assigned the same reference numerals, and descriptions of those structural elements are simplified or omitted.

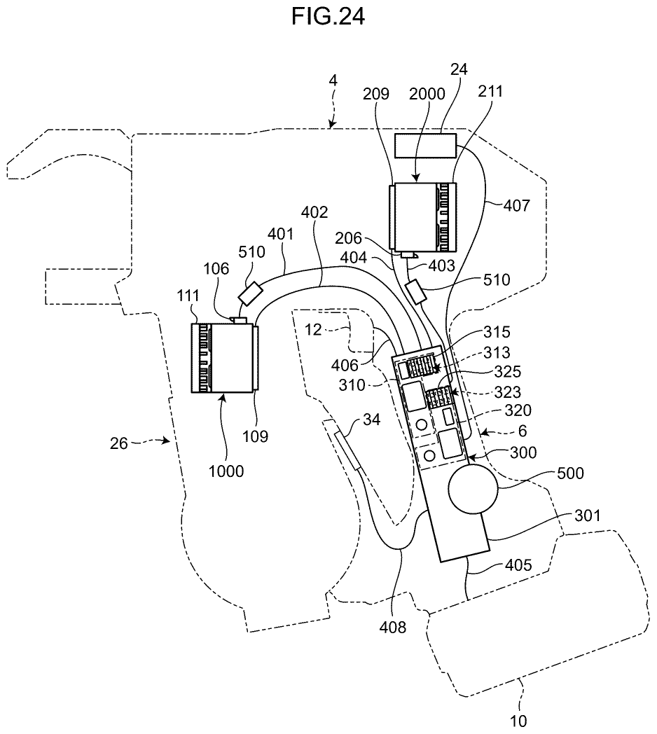

FIG. 24 is a diagram schematically showing a layout example of the controller 300 according to the present embodiment. As compared to the configuration shown in the first embodiment described above, a wireless-communication unit 500, heat sinks (315, 325), and noise-removing members (noise attenuating devices) 510 are further provided in the tenth embodiment.

The wireless-communication unit 500 is provided in the grip part 6. The wireless-communication unit 500 is disposed in the grip part 6 so as to overlap the circuit board 301 of the controller 300 in the left-right direction. The wireless-communication unit 500 is disposed in the grip part 6 leftward of the circuit board 301. The wireless-communication unit 500 is disposed between the circuit board 301 and the left housing 20. The wireless-communication unit 500 may be disposed in the grip part 6 rightward of the circuit board 301. The wireless-communication unit 500 may be disposed, for example, between the circuit board 301 and the right housing 18.

The wireless-communication unit 500 may be detachable from the housing 16. A mounting opening for mounting the wireless-communication unit 500 may be formed, for example, in an outer surface of the left housing 20 (or an outer surface of the right housing 18), and the wireless-communication unit 500 may be configured to be mounted in the mounting opening from the exterior of the housing 16. Thus, in this configuration, an electrical connection with the controller 300 is established by mounting the wireless-communication unit 500 in the mounting opening. In addition, the wireless-communication unit 500 may be provided in (on) the head part 4, the foot part 8, or the battery 10.

In FIG. 24, the wireless-communication unit 500 can be electrically connected to the controller 300 by a wired connection or can be mounted directly on the circuit board 301. The controller 300 supplies electric power from the battery 10 to the wireless-communication unit 500. The controller 300 communicates with external equipment via the wireless-communication unit 500.

The wireless-communication unit 500 comprises an interface circuit for performing wireless communication. The wireless communication scheme is not particularly limited. The wireless-communication unit 500 communicates via, for example: near-field communication, such as Bluetooth®; WLAN communication, such as Wi-Fi®; microwaves; infrared rays (optical signals); a mobile-communication system, such as so-called 5G; or the like. The wireless-communication unit 500 is capable of communicating with another communications terminal—for example: a computer; a mobile device; a cloud server; a power tool, such as another rebar-tying tool; an external battery unit; or the like—via wireless communication. As one example, the wireless-communication unit 500 communicates with a terminal (such as a tablet-type terminal or a PC) that is for managing a power tool or power tools possessed by the user, including the rebar-tying tool 2.

The controller 300 can transmit information concerning the rebar-tying tool 2 via the wireless-communication unit 500. The information concerning the rebar-tying tool 2 can include, for example, information such as remaining charge, voltage value, electric-current value, etc., of the battery 10. The information concerning the rebar-tying tool 2 can include, for example, information or log data concerning the motors in the rebar-tying tool 2. The information concerning the motors can include motor rotational speed, torque, rotational direction, etc. The information concerning the rebar-tying tool 2 can include the present settings (action mode, etc.) of the rebar-tying tool 2. The information concerning the rebar-tying tool 2 can include, for example, cumulative value of the rebar tying count or the remaining amount of wire wound on the reel 33 (remaining tying count). In such an embodiment, the controller 300 may tally the rebar tying count based on drive information of a feed motor 1000 and compute the remaining tying count by subtracting a count value from an initial value of the tying count set in the reel 33. The controller 300 may periodically transmit this information concerning the rebar-tying tool 2 to a set transmission destination and may transmit the information concerning the rebar-tying tool 2 in response to a request from the transmission destination. The controller 300 can receive a control signal via the wireless-communication unit 500. The control signal can include information that directs switching the power supply of the rebar-tying tool 2 ON or OFF or information that directs changing the action mode of the rebar-tying tool 2. The controller 300 controls the components of the rebar-tying tool 2 in accordance with the control signal received.

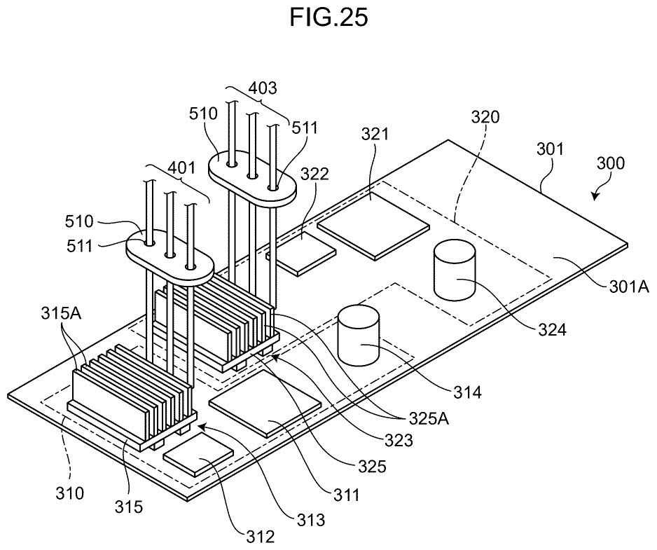

FIG. 25 is an oblique schematic view showing the controller 300 according to the present embodiment. The controller 300 comprises the circuit board 301, which comprises the inverter circuits (313, 323) for motor driving, and the heat sinks (315, 325), which are thermally connected to the inverter circuits. That is, the circuit board 301 comprises the heat sink 315, which is thermally connected to the inverter circuit 313 of the first control circuit 310. The heat sink 315 contacts the inverter circuit 313 via a thermally conductive material on surfaces of the switching elements that constitute the inverter circuit 313. The thermally conductive material is a thermally conductive grease, a thermally conductive bonding agent, or the like, and fills the gap between the surface of the heat sink 315 and the surfaces of the switching elements. The heat sink 315 comprises: a main-body part, which has a heat-transfer surface that contacts an object whose heat is to be absorbed, such as each switching element; and a plurality of fins 315A, which rise up from the main-body part. The fins 315A have a shape, such as a plate shape, a pin shape, or a lattice shape, and increase the heat-dissipating surface area of the heat sink 315. The heat sink 315 is composed of a highly thermally conductive material, such as an aluminum material (aluminum or an aluminum alloy). One heat sink 315 may be provided for one switching element, or one heat sink 315 may be provided for a plurality of the switching elements. The inverter circuit 313 can include, for example, one or two power modules in which a plurality of the switching elements is packaged. In this situation, the heat sink 315 may be installed on each power module.

The circuit board 301 comprises the heat sink 325, which is thermally connected to the inverter circuit 323 of the second control circuit 320. The heat sink 325 contacts the inverter circuit 323 via a thermally conductive material on surfaces of the switching elements that constitute the inverter circuit 323. The thermally conductive material is a thermally conductive grease, a thermally conductive bonding agent, or the like, and fills the gap between the surface of the heat sink 325 and the surfaces of the switching elements. The heat sink 325 comprises: a main-body part, which has a heat-transfer surface that contacts an object whose heat is to be absorbed, such as each switching element; and a plurality of fins 325A, which rise up from the main-body part. The fins 325A have a shape, such as a plate shape, a pin shape, or a lattice shape, and increase the heat-dissipating surface area of the heat sink 325. The heat sink 325 is composed of a highly thermally conductive material, such as an aluminum material (aluminum or an aluminum alloy). One heat sink 325 may be provided for one switching element, or one heat sink 325 may be provided for a plurality of the switching elements. The inverter circuit 323 can include, for example, one or two power modules in which a plurality of the switching elements are packaged. In this situation, the heat sink 325 may be installed on each power module.

The rebar-tying tool 2 comprises the noise-removing members 510 that remove (attenuate) electromagnetic noise on electric-power lines that electrically connect at least one of the feed motor 1000 (first brushless motor) and a twisting motor 2000 (second brushless motor) with the controller 300. Each of the noise-removing members 510 is provided in common with a plurality of electric-power lines. Each of the noise-removing members 510 is a plate-shaped member in which a plurality of through holes 511, through which the electric-power lines respectively pass, is formed. That is, one electric-power line is inserted through each of the through holes 511. In FIG. 25, each of the noise-removing members 510 is an oval-shaped flat plate, and three of the through holes 511 are provided therein passing through in the thickness direction. In plan view, the three through holes 511 are aligned along a straight line in the longitudinal-axis direction of each of the noise-removing members 510. Each of the noise-removing members 510 is composed of a ferromagnetic body. Each of the noise-removing members 510 is, for example, a permanent magnet.

In FIG. 25, two of the noise-removing members 510 are provided. The first noise-removing member 510 is provided on the power cables 401, which supply electric power to the feed motor 1000. The three electric-power lines (U-phase, V-phase, and W-phase electric-power lines) that constitute the power cables 401 are inserted through the three through holes 511, respectively, of the first noise-removing member 510. The second noise-removing member 510 is provided on the power cables 403, which supply electric power to the twisting motor 2000. The three electric-power lines (U-phase, V-phase, and W-phase electric-power lines) that constitute the power cables 403 are inserted through the three through holes 511, respectively, of the second noise-removing member 510.

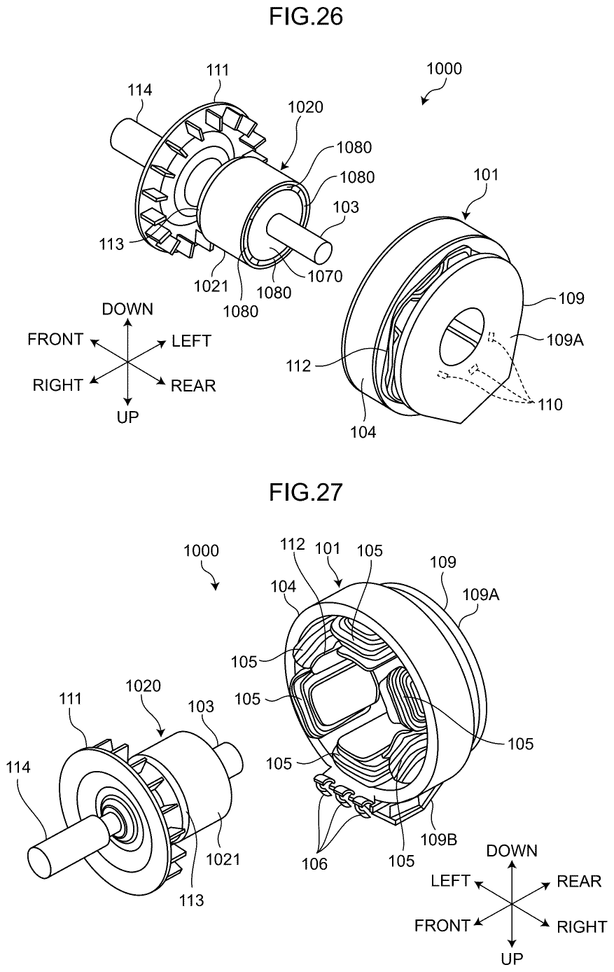

FIG. 26 is an exploded, oblique view, viewed from the rear right and below, of the feed motor 1000 according to the present embodiment. FIG. 27 is an exploded, oblique view, viewed from the front right and below, that shows the feed motor 1000 according to the present embodiment. The above-mentioned first embodiment (see FIG. 4 and FIG. 5) described the feed motor 100, which is an IPM (interior permanent magnet) motor, in which the rotor magnets 108 are disposed in magnet holes provided in the rotor core 107; however, in the examples shown in FIG. 26 and FIG. 27, the feed motor 1000 is an SPM (surface permanent magnet) motor, in which rotor magnets 1080 are disposed on an outer circumferential surface of a rotor core 1070.

A rotor 1020 of the feed motor 1000 comprises the rotor core 1070, the rotor magnets 1080, and a retaining tube 1021. The rotor magnets 1080 are fixed to the rotor core 1070. The rotor magnets 1080 are disposed on the outer circumferential surface of the rotor core 1070. The rotor magnets 1080 are curved along the outer circumferential surface of the rotor core 1070. The rotor magnets 1080 are fixed to the outer circumferential surface of the rotor core 1070 by bonding, or the like. In the present embodiment, four of the rotor magnets 1080 are disposed in the circumferential direction of the rotor core 1070. The feed motor 1000 has a pole count of four. The number of rotor magnets 1080 is not particularly limited and may be a number other than four. The retaining tube 1021 has a circular-tube shape. The retaining tube 1021 encircles the outer circumferences of the rotor magnets 1080. An inner circumferential surface of the retaining tube 1021 presses the outer surfaces of the rotor magnets 1080 toward the rotor core 1070 (toward the center in the radial direction). The retaining tube 1021 prevents the rotor magnets 1080 from separating from the rotor core 1070. The retaining tube 1021 is composed of a steel material, a resin material, or the like.

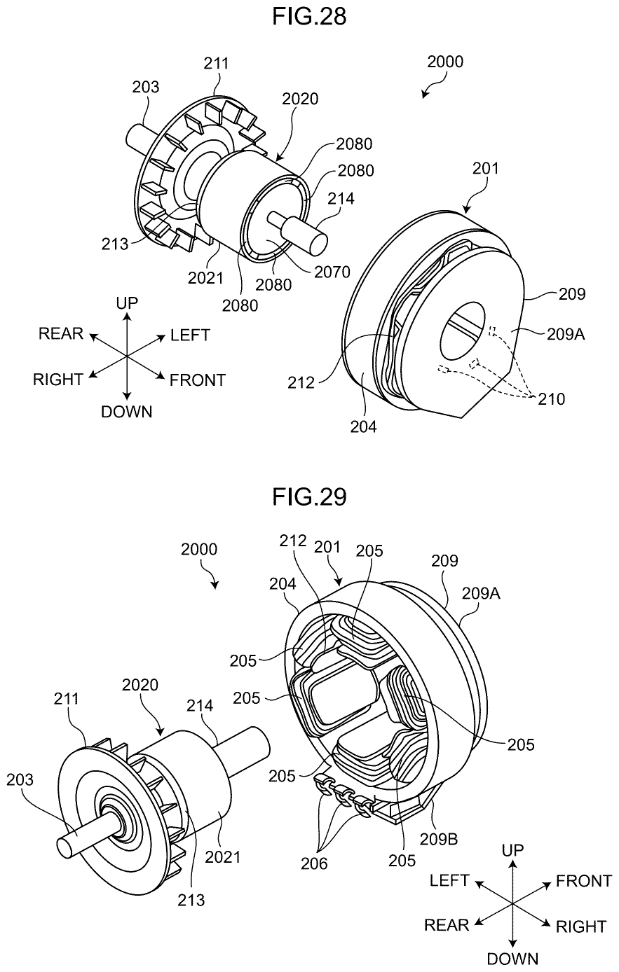

FIG. 28 is an exploded, oblique view, viewed from the rear right and below, of the twisting motor 2000 according to the present embodiment. FIG. 29 is an exploded, oblique view, viewed from the front right and below, of the twisting motor 2000 according to the present embodiment. The above-mentioned first embodiment (see FIG. 6 and FIG. 7) described the twisting motor 200, which is an IPM motor; however, in the examples shown in FIG. 28 and FIG. 29, the twisting motor 2000 is an SPM motor, in which rotor magnets 2080 are disposed on an outer circumferential surface of a rotor core 2070.

A rotor 2020 of the twisting motor 2000 comprises the rotor core 2070, the rotor magnets 2080, and a retaining tube 2021. The rotor magnets 2080 are fixed to the rotor core 2070. The rotor magnets 2080 are disposed on the outer circumferential surface of the rotor core 2070. The rotor magnets 2080 are curved along the outer circumferential surface of the rotor core 2070. The rotor magnets 2080 are fixed to the outer circumferential surface of the rotor core 2070 by bonding, or the like. In the present embodiment, four of the rotor magnets 2080 are disposed in the circumferential direction of the rotor core 2070. The twisting motor 2000 has a pole count of four. The number of rotor magnets 2080 is not particularly limited and may be a number other than four. The retaining tube 2021 has a circular-tube shape. The retaining tube 2021 encircles the outer circumferences of the rotor magnets 2080. An inner circumferential surface of the retaining tube 2021 presses the outer surfaces of the rotor magnets 2080 toward the rotor core 2070. The retaining tube 2021 prevents the rotor magnets 2080 from separating from the rotor core 2070. The retaining tube 2021 is composed of a steel material, a resin material, or the like.

Instead of the feed motor 100 and the twisting motor 200, the feed motor 1000 and the twisting motor 2000 in FIG. 26 through FIG. 29 may be provided in the second embodiment through the ninth embodiment described above.

As explained above, in the tenth embodiment, the controller 300 comprises the circuit board 301, which comprises: the inverter circuit 313 for motor driving of the feed motor 1000, which is the first brushless motor; and the heat sink 315, which is thermally connected to the inverter circuit 313.

In the above-mentioned configuration, temperature rises in the controller 300 are curtailed.

In the tenth embodiment, the controller 300 comprises the circuit board 301, which comprises: the inverter circuit 323 for motor driving of the twisting motor 200, which is the second brushless motor; and the heat sink 325, which is thermally connected to the inverter circuit 323.

In the above-mentioned configuration, temperature rises in the controller 300 can be curtailed.

In the tenth embodiment, the rebar-tying tool 2 further comprises the wireless-communication unit 500, which is provided in the grip part 6.

In the above-mentioned configuration, the wireless-communication unit 500 and the controller 300 are disposed with a suitable positional relationship.

In the tenth embodiment, the rebar-tying tool 2 comprises the first noise-removing member 510, which removes electromagnetic noise on the electric-power lines of the power cables 401 that connect the feed motor 1000, which is the first brushless motor, and the controller 300 to each other. The rebar-tying tool 2 comprises the second noise-removing member 510, which removes electromagnetic noise on the electric-power lines of the power cables 403 that connect the twisting motor 2000, which is the second brushless motor, and the controller 300 to each other.

In the above-mentioned configuration, in addition to disposing the brushless motors (the feed motor 1000 and the twisting motor 2000) and the controller 300 in a suitable positional relationship, the influence of electromagnetic noise can be curtailed.

### Eleventh Embodiment

An eleventh embodiment will be described. In the explanation below, structural elements that are identical or equivalent to those in the embodiments described above are assigned the same reference numerals, and descriptions of those structural elements are simplified or omitted.

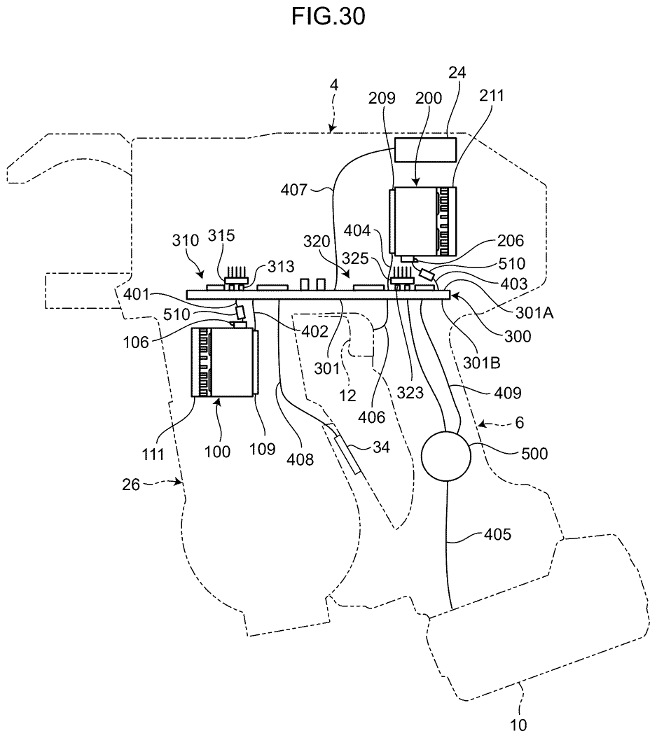

FIG. 30 is a diagram schematically showing a layout example of the controller 300 according to the present embodiment. As compared to the configuration shown in the second embodiment described above, the wireless-communication unit 500, the heat sinks (315, 325), and, further, the noise-removing members 510 are provided in the eleventh embodiment.

The controller 300 is disposed in the head part 4. The controller 300 is disposed between the feed motor 100 and the twisting motor 200 in the up-down direction. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces upward.

The first control circuit 310 is mounted on the forward side of the circuit board 301. The heat sink 315 is provided on the inverter circuit 313 of the first control circuit 310. The heat sink 315 contacts the inverter circuit 313 via a thermally conductive material on the surfaces of the switching elements that constitute the inverter circuit 313. The second control circuit 320 is mounted on the rearward side of the circuit board 301. The heat sink 325 is provided on the inverter circuit 323 of the second control circuit 320. The heat sink 325 contacts the inverter circuit 323 via a thermally conductive material on the surfaces of the switching elements that constitute the inverter circuit 323. Consequently, the heat sink 315 and the heat sink 325 are provided on the first surface 301A side of the circuit board 301.

The wireless-communication unit 500 is disposed in the grip part 6. The wireless-communication unit 500 is connected to the controller 300 via a wired connection. The wireless-communication unit 500 is connected to the second surface 301B of the circuit board 301 via a wired connection by a connecting cable 409. The connecting cable 409 comprises a signal line and a power line. The controller 300 supplies electric power from the battery 10 to the wireless-communication unit 500 via the connecting cable 409. The controller 300 exchanges signals with the wireless-communication unit 500 via the connecting cable 409.

The second surface 301B of the circuit board 301 and the feed motor 100 are electrically connected by the power cables 401. The first noise-removing member 510 is provided on the power cables 401, which supply electric power to the feed motor 100. The first noise-removing member 510 is disposed between the second surface 301B of the circuit board 301 and the feed motor 100. The three electric-power lines (U-phase, V-phase, and W-phase electric-power lines) that constitute the power cables 401 are inserted through the three through holes 511 (see FIG. 25), respectively, of the first noise-removing member 510. The first surface 301A of the circuit board 301 and the twisting motor 200 are electrically connected by the power cables 403. The second noise-removing member 510 is provided on the power cables 403, which supply electric power to the twisting motor 200. The second noise-removing member 510 is disposed between the first surface 301A of the circuit board 301 and the twisting motor 200. The three electric-power lines (U-phase, V-phase, and W-phase electric-power lines) that constitute the power cables 403 are inserted through the three through holes 511 (see FIG. 25), respectively, of the second noise-removing member 510.

The wireless-communication unit 500, the heat sinks 315, 325, and the noise-removing members 510 may be provided in the third embodiment described above.

### Twelfth Embodiment

A twelfth embodiment will be described. In the explanation below, structural elements that are identical or equivalent to those in the embodiments described above are assigned the same reference numerals, and descriptions of those structural elements are simplified or omitted.

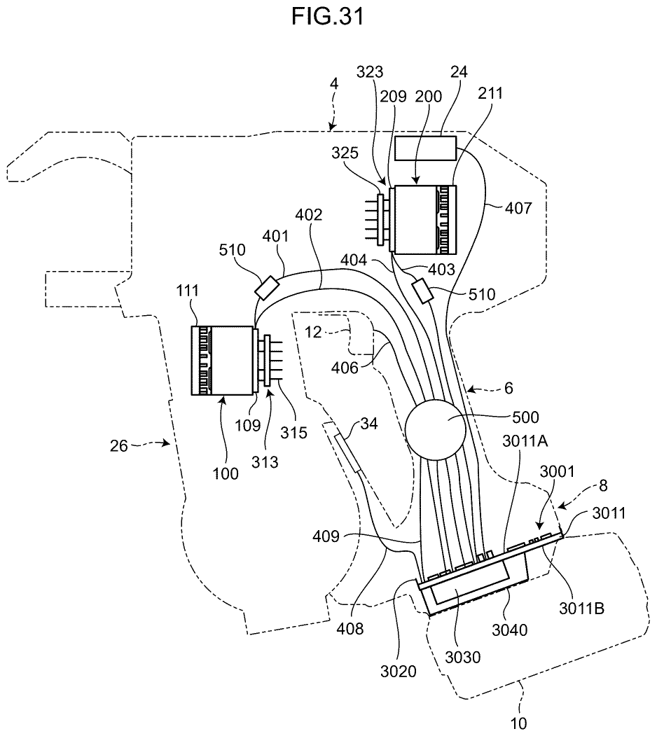

FIG. 31 is a diagram schematically showing a layout example of the controller 3001 according to the present embodiment. As compared to the configuration shown in the ninth embodiment described above, the wireless-communication unit 500, the heat sinks 315, 325, and, further, the noise-removing members 510 are provided in the twelfth embodiment.

The controller 3001 is disposed in the foot part 8. The controller 3001 is disposed in the foot part 8 so that the circuit board 3011 extends in the front-rear direction. The controller 3001 is disposed in the foot part 8 so that the first surface 3011A of the circuit board 3011, on which the first control circuit 310 and the second control circuit 320 are mounted, faces upward.

The sensor board 109 is disposed on the feed motor 100. The inverter circuit 313, which is for controlling the feed motor 100, is provided on the sensor board 109. Consequently, the inverter circuit 313 is not provided on the first control circuit 310. The heat sink 315 is provided on the inverter circuit 313 of the sensor board 109. The heat sink 315 contacts the inverter circuit 313 via a thermally conductive material on the surfaces of the switching elements that constitute the inverter circuit 313.

The sensor board 209 is disposed on the twisting motor 200. The inverter circuit 323, which is for controlling the twisting motor 200, is provided on the sensor board 209. Consequently, the inverter circuit 323 is not provided on the second control circuit 320. The heat sink 325 is provided on the inverter circuit 323 of the sensor board 209. The heat sink 325 contacts the inverter circuit 323 via a thermally conductive material on the surfaces of the switching elements that constitute the inverter circuit 323.

The wireless-communication unit 500 is disposed in the grip part 6. The wireless-communication unit 500 is electrically connected to the controller 300 by the connecting cable 409.

The circuit board 3011 and the sensor board 109 are electrically connected by the power cables 401 and the signal cables 402. The first noise-removing member 510 is provided on the power cables 401. The first noise-removing member 510 is disposed between the circuit board 3011 and the sensor board 109. The three electric-power lines (U-phase, V-phase, and W-phase electric-power lines) that constitute the power cables 401 are inserted through the three through holes 511 (see FIG. 25), respectively, of the first noise-removing member 510. The circuit board 3011 and the sensor board 209 are electrically connected by the power cables 403 and the signal cables 404. The second noise-removing member 510 is provided on the power cables 403. The second noise-removing member 510 is disposed between the circuit board 3011 and the sensor board 209. The three electric-power lines (U-phase, V-phase, and W-phase electric-power lines) that constitute the power cables 403 are inserted through the three through holes 511 (see FIG. 25), respectively, of the second noise-removing member 510.

### EXPLANATION OF THE REFERENCE NUMBERS

2 Rebar-tying tool
4 Head part
6 Grip part
8 Foot part
10 Battery
12 Trigger
16 Housing
18 Right housing
20 Left housing
22 Motor cover
24 First operation-and-indicator part
26 Coupling part
28 Cover member
32 Lock lever
33 Reel
34 Second operation-and-indicator part
38 Wire-feeding mechanism
40 Wire-guiding mechanism
42 Rebar-abutting mechanism
44 Wire-cutting mechanism
46 Wire-twisting mechanism
48 Rebar-pressing mechanism
58 Contact plate
60 Contact plate
118 Contact arm
100 Feed motor (first brushless motor)
101 Stator
102 Rotor
103 Rotor shaft
104 Stator core
105 Coil
106 Terminal
107 Rotor core
108 Rotor magnet
109 Sensor board
109A Circuit-board part
109B Support part
110 Magnetic sensor
111 Fan
112 Insulator
113 Balance-correcting plate
114 Output pinion
200 Twisting motor (second brushless motor)
201 Stator
202 Rotor
203 Rotor shaft
204 Stator core
205 Coi
206 Terminal
207 Rotor core
208 Rotor magnet
209 Sensor board
209A Circuit-board part
209B Support part
210 Magnetic sensor
211 Fan
212 Insulator
213 Balance-correcting plate
214 Output pinion
300 Controller
301 Circuit board
301A First surface
301B Second surface
310 First control circuit
311 Microcomputer
312 Gate-driver circuit
313 Inverter circuit
314 Capacitor
320 Second control circuit
321 Microcomputer
322 Gate-driver circuit
323 Inverter circuit
324 Capacitor
330 Holding part
401 Power cable
402 Signal cable
403 Power cable
404 Signal cable
405 Power-supplying cable
406 Signal cable
407 Signal cable
408 Signal cable
409 Connecting cable
1000 Feed motor
1020 Rotor
1021 Retaining tube
1070 Rotor core
1080 Rotor magnet
2000 Twisting motor
2020 Rotor
2021 Retaining tube
2070 Rotor core
2080 Rotor magnet
3000 Controller
3001 Controller
3010 Circuit board
3011 Circuit board
3011A First surface
3011B Second surface
3020 Controller case
3030 Terminal
3040 Guide

1. A rebar-tying tool comprising:
a first brushless motor, which feeds a wire that is wound on a reel;
a second brushless motor, which twists the wire;
a head part, in which the second brushless motor is disposed;
a grip part, which extends downward from the head part;
a foot part, which is disposed downward of the grip part and to which a battery connects;
a coupling part, which is disposed forward of the grip part, couples the head part and the foot part, and in which the reel and the first brushless motor are disposed; and
a controller, which controls the first brushless motor and the second brushless motor;
wherein the controller is disposed in the grip part.

2. The rebar-tying tool according to claim 1, wherein a first cable, which connects the first brushless motor and the controller, passes through the head part.

3. The rebar-tying tool according to claim 1, comprising:
an operation-and-indicator part, which is disposed in the head part;
wherein the operation-and-indicator part and the controller are connected by a second cable.

4. The rebar-tying tool according to claim 1, wherein:
the first brushless motor comprises a first stator and a first rotor, which is disposed in the interior of the first stator;
the first brushless motor is disposed so that the rotational axis of the first rotor extends in a front-rear direction;
a first terminal, which connects a plurality of coils of the first stator, is disposed at an upper portion of the first stator;
a first sensor board, which detects rotation of the first rotor, is disposed more rearward than the first stator;
the first terminal and the controller are connected by a first power cable; and
the first sensor board and the controller are connected by a first signal cable.

5. The rebar-tying tool according to claim 1, wherein:
the second brushless motor comprises a second stator and a second rotor, which is disposed in the interior of the second stator;
the second brushless motor is disposed so that the rotational axis of the second rotor extends in a front-rear direction;
a second terminal, which connects a plurality of coils of the second stator, is disposed at a lower portion of the second stator;
a second sensor board, which detects rotation of the second rotor, is disposed more forward than the second stator;
the second terminal and the controller are connected by a second power cable; and
the second sensor board and the controller are connected by a second signal cable.

6. A rebar-tying tool comprising:
a first brushless motor, which feeds a wire that is wound on a reel;
a second brushless motor, which twists the wire;
a head part, in which the second brushless motor is disposed;
a grip part, which extends downward from the head part;
a foot part, which is disposed downward of the grip part and to which a battery connects;
a coupling part, which is disposed forward of the grip part, couples the head part and the foot part, and in which the reel and the first brushless motor are disposed; and
a controller, which controls the first brushless motor and the second brushless motor;
wherein the controller is disposed between the first brushless motor and the second brushless motor in an up-down direction.

7. The rebar-tying tool according to claim 6, wherein:
the first brushless motor and the controller are connected by a first cable; and
the first cable is connected to a lower surface of a circuit board of the controller.

8. The rebar-tying tool according to claim 6, comprising:
an operation-and-indicator part, which is disposed in the head part;
wherein:
the operation-and-indicator part and the controller are connected by a second cable; and
the second cable is connected to an upper surface of a circuit board of the controller.

9. The rebar-tying tool according to claim 6, wherein:
the first brushless motor comprises a first stator and a first rotor, which is disposed in the interior of the first stator;
the first brushless motor is disposed so that the rotational axis of the first rotor extends in a front-rear direction;
a first terminal, which connects a plurality of coils of the first stator, is disposed at an upper portion of the first stator;
a first sensor board, which detects rotation of the first rotor, is disposed more rearward than the first stator;
the first terminal and the controller are connected by a first power cable; and
the first sensor board and the controller are connected by a first signal cable.

10. The rebar-tying tool according to claim 6, wherein:
the second brushless motor comprises a second stator and a second rotor, which is disposed in the interior of the second stator;
the second brushless motor is disposed so that the rotational axis of the second rotor extends in a front-rear direction;
a second terminal, which connects a plurality of coils of the second stator, is disposed at a lower portion of the second stator;
a second sensor board, which detects rotation of the second rotor, is disposed more forward than the second stator;
the second terminal and the controller are connected by a second power cable; and
the second sensor board and the controller are connected by a second signal cable.

11. A rebar-tying tool comprising:
a first brushless motor, which feeds a wire that is wound on a reel;
a second brushless motor, which twists the wire;
a head part, in which the second brushless motor is disposed;
a grip part, which extends downward from the head part;
a foot part, which is disposed downward of the grip part and to which a battery connects;
a coupling part, which is disposed forward of the grip part, couples the head part and the foot part, and in which the reel and the first brushless motor are disposed; and
a controller, which comprises a circuit board and controls the first brushless motor and the second brushless motor;
wherein:
a second surface of the circuit board and the first brushless motor are connected by a cable; and
a first surface of the circuit board and the second brushless motor are connected by a cable.

12. The rebar-tying tool according to claim 11, wherein the controller is disposed in the head part.

13. The rebar-tying tool according to claim 11, comprising:
an operation-and-indicator part, which is disposed on the head part;
wherein the first surface of the circuit board and the operation-and-indicator part are connected by a cable.

14. The rebar-tying tool according to claim 11, wherein:
the first brushless motor comprises a first stator and a first rotor, which is disposed in the interior of the first stator;
the first brushless motor is disposed so that the rotational axis of the first rotor extends in a front-rear direction;
a first terminal, which connects a plurality of coils of the first stator, is disposed at an upper portion of the first stator;
a first sensor board, which detects rotation of the first rotor, is disposed more rearward than the first stator;
the first terminal and the controller are connected by a first power cable; and
the first sensor board and the controller are connected by a first signal cable.

15. The rebar-tying tool according to claim 11, wherein:
the second brushless motor comprises a second stator and a second rotor, which is disposed in the interior of the second stator;
the second brushless motor is disposed so that the rotational axis of the second rotor extends in a front-rear direction;
a second terminal, which connects a plurality of coils of the second stator, is disposed at a lower portion of the second stator;
a second sensor board, which detects rotation of the second rotor, is disposed more forward than the second stator;
the second terminal and the controller are connected by a second power cable; and
the second sensor board and the controller are connected by a second signal cable.

16. The rebar-tying tool according to claim 1, wherein:
at least one of the first brushless motor and the second brushless motor has a sensor board, which detects the rotation of a rotor; and
the sensor board has an inverter circuit for driving the motor.

17. The rebar-tying tool according to claim 1, wherein:
the controller comprises a circuit board, which comprises: an inverter circuit for driving the motor; and a heat sink, which is thermally connected to the inverter circuit.

18. The rebar-tying tool according to claim 1, further comprising a wireless-communication unit, which is provided in the grip part.

19. The rebar-tying tool according to claim 1, comprising a noise-removing member, which removes electromagnetic noise on an electric-power line that connects at least one of the first brushless motor and the second brushless motor with the controller.

20. A rebar-tying tool comprising:
a first brushless motor, which feeds a wire that is wound on a reel;
a second brushless motor, which twists the wire;
a head part, in which the second brushless motor is disposed;
a grip part, which extends downward from the head part;
a foot part, which is disposed downward of the grip part and to which a battery connects;
a coupling part, which is disposed forward of the grip part, couples the head part and the foot part, and in which the reel and the first brushless motor are disposed; and
a controller, which controls the first brushless motor and the second brushless motor;
wherein:
the controller is disposed in the foot part; and
the controller comprises: a circuit board; a controller case, which houses the circuit board; and a terminal, which connects the battery and the circuit board.
